(19) United States
(12) Patent Application Publication
(10) Pub. No.: US 2026/0253489 A1
(43) Pub. Date: Aug. 27, 2026

(54) SYSTEM

(71) Applicant: SoftBank Group Corp., Tokyo (JP)

(72) Inventor: Yusaku MORI, Tokyo (JP)

(73) Assignee: SoftBank Group Corp., Tokyo (JP)

(21) Appl. No.: 19/536,298

(22) Filed: Feb. 11, 2026

(30) Foreign Application Priority Data
Feb. 21, 2025 (JP) 2025-027066

(51) Int. Cl. G08G 1/01

(52) U.S. Cl. CPC G08G 1/0104

(57) ABSTRACT

The system according to the embodiment comprises a collection unit, an analysis unit, a proposal unit, a signal control unit, a parking management unit, and an operation adjustment unit. The collection unit collects traffic flow data or sensor information. The analysis unit analyzes data collected by the collection unit. The proposal unit proposes a traffic route based on an analysis result obtained by the analysis unit. The signal control unit performs signal control based on a route proposed by the proposal unit. The parking management unit performs parking management based on a route proposed by the proposal unit. The operation adjustment unit adjusts public transportation operation based on a route proposed by the proposal unit.

### CROSS-REFERENCE TO RELATED APPLICATION

The present application claims priority to and incorporates by reference the entire contents of Japanese Patent Application No. 2025-027066 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, traffic flow data and sensor information have not been sufficiently utilized to solve traffic congestion and environmental problems, and there is room for improvement.

### SUMMARY OF THE INVENTION

The system according to the embodiment comprises a collection unit, an analysis unit, a proposal unit, a signal control unit, a parking management unit, and an operation adjustment unit. The collection unit collects traffic flow data or sensor information. The analysis unit analyzes data collected by the collection unit. The proposal unit proposes a traffic route based on an analysis result obtained by the analysis unit. The signal control unit performs signal control based on a route proposed by the proposal unit. The parking management unit performs parking management based on a route proposed by the proposal unit. The operation adjustment unit adjusts public transportation operation based on a route proposed by the proposal unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

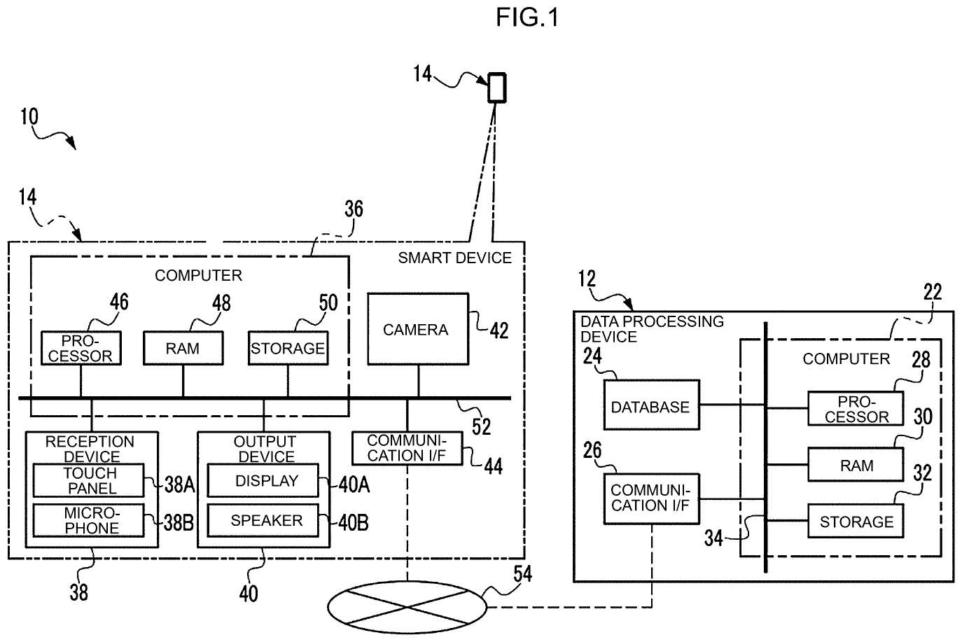

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

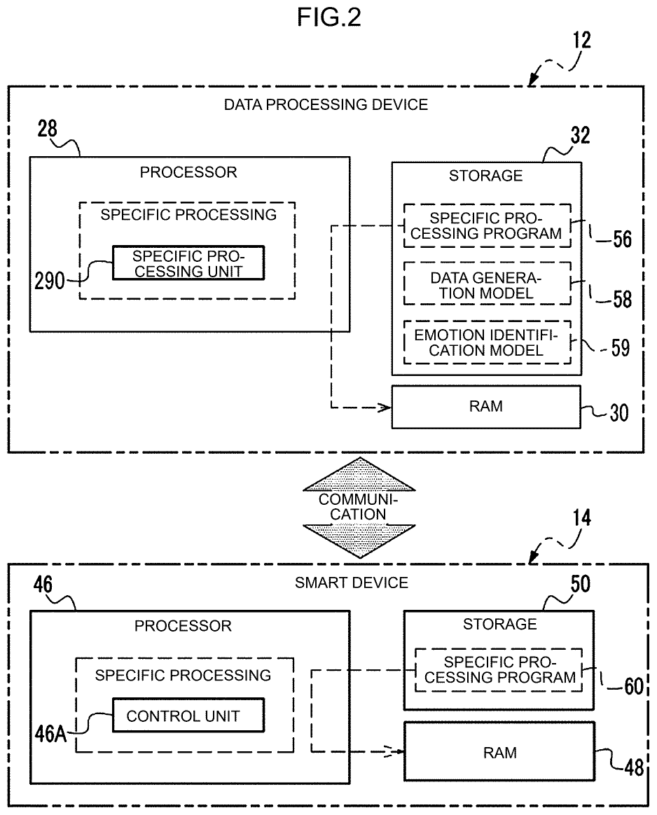

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The traffic management system according to the embodiment of the present invention is a system that utilizes traffic flow data and sensor information to propose efficient traffic routes and optimize signal control, parking management, and public transportation operation adjustment. This traffic management system collects traffic flow data and sensor information, analyzes them using AI, and proposes efficient traffic routes. Furthermore, by optimizing signal control, parking management, and public transportation operation adjustment, the system solves urban traffic congestion and environmental problems. For example, the traffic management system collects data from sensors and cameras installed on roads, enabling real-time grasp of traffic conditions. Next, the collected data is analyzed by AI, which proposes efficient traffic routes, such as routes that avoid congested roads or routes that reach the destination by the shortest distance. Additionally, signal control, parking management, and public transportation operation adjustment are optimized. The AI adjusts signal timing based on traffic flow data to smooth the flow of traffic. It also grasps the availability status of parking lots in real time and performs efficient parking management. Furthermore, it adjusts the operation schedule of public transportation to reduce passenger waiting time. As a result, the overall traffic efficiency of the city is improved and environmental impact is reduced. For example, reducing traffic congestion decreases vehicle fuel consumption and reduces CO2 emissions. Efficient parking management shortens the time spent searching for parking lots and reduces unnecessary driving. Moreover, by adjusting public transportation operation, passenger waiting time is shortened and the use of public transportation is promoted. Thus, the overall traffic efficiency of the city is improved and environmental impact is reduced. Consequently, the traffic management system can alleviate urban traffic congestion and is expected to improve environmental issues. Specifically, the traffic management system collects high-dimensional data obtained from various hardware such as multiple road sensors (e.g., magnetic sensors, pressure sensors, infrared sensors), cameras (e.g., high-resolution network cameras, all-weather cameras), radar, and LIDAR, including image tensors (1920×1080×3), time-series traffic volume vectors (24 hours at 1-minute intervals), and vehicle attribute label arrays. The system performs noise removal, normalization, and feature extraction (e.g., vehicle detection, lane recognition, congestion scoring) in a preprocessing unit and inputs the data to an analysis unit. The analysis unit combines convolutional neural networks (CNN), recurrent neural networks (RNN), and transformer-based time-series prediction models to perform traffic flow prediction (e.g., congestion scores for each intersection 5 minutes ahead, continuous values from 0 to 1), anomaly detection (e.g., accident occurrence probability, such as 0.85), and route optimization (e.g., recommended route ID array from point A to point B). Examples of AI input include (1) camera image tensor (1920×1080×3), (2) traffic volume vector for the past 30 minutes (30 dimensions), and (3) category vector for weather, time zone, and event information (10 dimensions). Examples of AI output include (1) congestion prediction scores for each route (e.g., 0.1, 0.3, 0.8), (2) recommended route ID (e.g., route 3), and (3) signal control timing (e.g., green light extension by 5 seconds). These outputs are transmitted to subsequent signal control units, parking management units, and operation adjustment units, and are used for threshold judgment (e.g., signal extension if congestion score is 0.7 or higher), branching processing (e.g., proposing alternative routes if parking lots are full), and input to other modules (e.g., transmitting congestion prediction values to the operation adjustment unit). Unlike conventional human traffic monitoring and rule-based control, the present invention enables AI to perform multivariate analysis of high-dimensional data and learn nonlinear patterns and time-series dependencies, thereby greatly improving the accuracy of traffic flow prediction and control optimization. For example, vehicle detection accuracy by CNN image analysis exceeds 99%, and congestion prediction error by RNN is reduced by 30% compared to conventional methods. Furthermore, data linkage with multiple cities and other systems enables wide-area traffic optimization and rapid response during disasters. Application fields include urban traffic control centers, smart cities, airport and port traffic management, traffic guidance during large-scale events, and vehicle flow optimization at logistics hubs. Through these technical effects, the present invention can technically solve issues such as urban traffic efficiency, reduction of environmental impact, reduction of social costs, and improvement of user satisfaction.

The traffic management system according to the embodiment comprises a collection unit, an analysis unit, a proposal unit, a signal control unit, a parking management unit, and an operation adjustment unit. The collection unit collects traffic flow data or sensor information. Traffic flow data includes, for example, vehicle speed, vehicle count, and traffic volume. Sensor information includes, for example, cameras, radar, and LIDAR. The collection unit collects data from sensors or cameras installed on roads. For example, the collection unit collects video data from cameras installed on roads to grasp traffic conditions. The collection unit can also collect data from radar installed on roads to grasp vehicle speed and position. Furthermore, the collection unit can use LIDAR to obtain three-dimensional position information of vehicles. The analysis unit analyzes data collected by the collection unit. Analysis includes, for example, data processing methods and algorithms used. The analysis unit analyzes traffic flow based on the collected data and proposes efficient traffic routes. For example, the analysis unit proposes routes that avoid congested roads or routes that reach the destination by the shortest distance based on the collected data. The proposal unit proposes traffic routes based on analysis results obtained by the analysis unit. Proposal includes, for example, selection criteria for proposed routes and timing of proposals. The proposal unit proposes efficient traffic routes. For example, the proposal unit proposes routes that avoid congested roads or routes that reach the destination by the shortest distance. The signal control unit performs signal control based on routes proposed by the proposal unit. Signal control includes, for example, methods for adjusting signal timing and control algorithms. The signal control unit adjusts signal timing based on traffic flow data to smooth the flow of traffic. For example, the signal control unit adjusts signal cycles and signal change timing based on traffic flow data. The parking management unit performs parking management based on routes proposed by the proposal unit. Parking management includes, for example, methods for grasping parking lot availability and details of management systems. The parking management unit grasps the availability status of parking lots in real time and performs efficient parking management. For example, the parking management unit uses sensor detection or camera monitoring to grasp parking lot availability. The operation adjustment unit adjusts public transportation operation based on routes proposed by the proposal unit. Operation adjustment includes, for example, methods for adjusting public transportation operation schedules and adjustment algorithms. The operation adjustment unit adjusts the operation schedule of public transportation to reduce passenger waiting time. For example, the operation adjustment unit adjusts public transportation operation times and frequencies. Thus, the traffic management system according to the embodiment can alleviate urban traffic congestion and is expected to improve environmental issues. Specifically, the traffic management system collects high-dimensional data obtained from various hardware such as multiple road sensors (e.g., magnetic sensors, pressure sensors, infrared sensors), high-resolution network cameras, all-weather cameras, radar, and LIDAR, including image tensors (1920×1080×3), time-series traffic volume vectors (24 hours at 1-minute intervals), and vehicle attribute label arrays. The system performs noise removal, normalization, and feature extraction (e.g., vehicle detection, lane recognition, congestion scoring) in a preprocessing unit and inputs the data to an analysis unit. The analysis unit combines convolutional neural networks (CNN), recurrent neural networks (RNN), and transformer-based time-series prediction models to perform traffic flow prediction (e.g., congestion scores for each intersection 5 minutes ahead, continuous values from 0 to 1), anomaly detection (e.g., accident occurrence probability, such as 0.85), and route optimization (e.g., recommended route ID array from point A to point B). Examples of AI input include (1) camera image tensor (1920×1080×3), (2) traffic volume vector for the past 30 minutes (30 dimensions), and (3) category vector for weather, time zone, and event information (10 dimensions). Examples of AI output include (1) congestion prediction scores for each route (e.g., 0.1, 0.3, 0.8), (2) recommended route ID (e.g., route 3), and (3) signal control timing (e.g., green light extension by 5 seconds). These outputs are transmitted to subsequent signal control units, parking management units, and operation adjustment units, and are used for threshold judgment (e.g., signal extension if congestion score is 0.7 or higher), branching processing (e.g., proposing alternative routes if parking lots are full), and input to other modules (e.g., transmitting congestion prediction values to the operation adjustment unit). Unlike conventional human traffic monitoring and rule-based control, the present invention enables AI to perform multivariate analysis of high-dimensional data and learn nonlinear patterns and time-series dependencies, thereby greatly improving the accuracy of traffic flow prediction and control optimization. For example, vehicle detection accuracy by CNN image analysis exceeds 99%, and congestion prediction error by RNN is reduced by 30% compared to conventional methods. Furthermore, data linkage with multiple cities and other systems enables wide-area traffic optimization and rapid response during disasters. Application fields include urban traffic control centers, smart cities, airport and port traffic management, traffic guidance during large-scale events, and vehicle flow optimization at logistics hubs. Through these technical effects, the present invention can technically solve issues such as urban traffic efficiency, reduction of environmental impact, reduction of social costs, and improvement of user satisfaction.

The collection unit can collect data from sensors or cameras installed on roads. For example, the collection unit collects video data from cameras installed on roads to grasp traffic conditions. The collection unit can also collect data from radar installed on roads to grasp vehicle speed and position. Furthermore, the collection unit can use LIDAR to obtain three-dimensional position information of vehicles. By collecting data from sensors or cameras installed on roads, real-time grasp of traffic conditions is possible. Some or all of the above-described processing in the collection unit may be performed using AI or without using AI. For example, the collection unit can input video data from cameras installed on roads to AI and have AI perform traffic condition recognition. Specifically, the collection unit combines multiple types of sensors (e.g., magnetic sensors, pressure sensors, infrared sensors), high-resolution cameras, all-weather cameras, millimeter-wave radar, and LIDAR to obtain high-dimensional data such as image tensors (1920×1080×3), time-series traffic volume vectors (24 hours at 1-minute intervals), and vehicle attribute label arrays. The collection unit performs noise removal, normalization, and feature extraction (e.g., vehicle detection, lane recognition, congestion scoring) in a preprocessing unit and transmits the data to the analysis unit. When using AI, for example, camera image tensors (1920×1080×3) are input to a convolutional neural network (CNN), and outputs such as vehicle detection labels (e.g., 10 vehicles, vehicle type classification label array) and congestion scores (0.8) can be obtained. Radar data (e.g., speed vectors, position vectors) can be input to a recurrent neural network (RNN) to obtain outputs such as movement prediction vectors for each vehicle and abnormal behavior scores. LIDAR data (e.g., point cloud data, 3D coordinate arrays) can be input to a graph neural network (GNN) or 3D-CNN to obtain outputs such as three-dimensional position estimation of vehicles and lane departure detection results. These AI outputs are transmitted to subsequent traffic condition recognition modules or anomaly detection modules and are used for threshold judgment (e.g., warning issued if congestion score is 0.7 or higher), branching processing (e.g., notification to security personnel upon abnormal behavior detection), and input to other modules (e.g., transmission of feature quantities to the analysis unit). Unlike conventional human monitoring or simple rule-based processing, the collection unit utilizes AI that learns nonlinear patterns and time-series dependencies through multivariate analysis of high-dimensional data, thereby greatly improving the accuracy and real-time performance of traffic condition recognition. For example, vehicle detection accuracy by CNN image analysis exceeds 99%, and speed prediction error by RNN is reduced by 30% compared to conventional methods. Application fields include urban traffic monitoring, smart cities, airport and port traffic management, and traffic guidance during large-scale events. Thus, the present invention can technically solve issues such as urban traffic efficiency, reduction of environmental impact, and reduction of social costs.

The analysis unit can analyze traffic flow based on collected data and propose routes that avoid congested roads or routes that reach the destination by the shortest distance. For example, the analysis unit proposes routes that avoid congested roads or routes that reach the destination by the shortest distance based on the collected data. The analysis unit needs to clarify specific analysis methods and criteria for traffic flow. For example, analysis is performed based on vehicle speed, vehicle count, and traffic volume. The definition and detection method of congestion also need to be clarified. For example, congestion may be defined as when vehicle speed is below a certain threshold or vehicle count exceeds a certain threshold. By analyzing traffic flow and proposing efficient routes, driver movement can be optimized. Some or all of the above-described processing in the analysis unit may be performed using AI or without using AI. For example, the analysis unit can input collected data to AI and have AI perform traffic flow analysis. Specifically, the analysis unit inputs preprocessed traffic flow data (e.g., time-series traffic volume vectors, vehicle speed arrays, image feature vectors) to AI models such as convolutional neural networks (CNN), recurrent neural networks (RNN), and transformer models. Examples of AI input include (1) traffic volume vector for the past 30 minutes (30 dimensions), (2) vehicle speed array for each intersection (10 intersections×5 vehicles=50 dimensions), and (3) camera image feature vector (512 dimensions). AI outputs include (1) congestion prediction scores for each road section (e.g., 0.1, 0.3, 0.8), (2) recommended route ID array (e.g., route 3, route 5), and (3) congestion occurrence probability (e.g., 0.85). The definition of congestion may be set by clear rules, such as “congestion is determined when vehicle speed is less than 20 km/h and traffic volume exceeds a threshold.” AI outputs are transmitted to subsequent proposal units and signal control units and are used for threshold judgment (e.g., signal extension if congestion score is 0.7 or higher), branching processing (e.g., proposing routes that avoid congested sections), and input to other modules (e.g., transmitting congestion prediction values to the parking management unit). Unlike conventional human traffic analysis or simple rule-based processing, the analysis unit utilizes AI that learns nonlinear patterns and time-series dependencies through multivariate analysis of high-dimensional data, thereby greatly improving the accuracy and speed of traffic flow analysis and route proposal. For example, congestion prediction error by RNN is reduced by 30% compared to conventional methods, and vehicle detection accuracy by CNN image analysis exceeds 99%. Application fields include urban traffic control centers, smart cities, and vehicle flow optimization at logistics hubs. Thus, the present invention can technically solve issues such as urban traffic efficiency, reduction of environmental impact, and improvement of user satisfaction.

The signal control unit can adjust signal timing based on traffic flow data to smooth the flow of traffic. For example, the signal control unit adjusts signal cycles and signal change timing based on traffic flow data. The specific adjustment methods and criteria for signal timing need to be clarified. For example, adjusting the signal cycle can smooth the flow of traffic, and adjusting the signal change timing can also smooth the flow of traffic. By adjusting signal timing, the flow of traffic can be made smoother. Some or all of the above-described processing in the signal control unit may be performed using AI or without using AI. For example, the signal control unit can input traffic flow data to AI and have AI perform signal timing adjustment. Specifically, the signal control unit inputs congestion scores and traffic volume vectors received from the analysis unit (e.g., congestion scores for each intersection from 0.1 to 0.9, traffic volume vectors for 10 intersections at 5-minute intervals) to a signal control AI (e.g., reinforcement learning-based control model, time-series prediction model). AI outputs include (1) extension or shortening times for green and red signals for each signal (e.g., green light extension by 5 seconds, red light shortening by 3 seconds), (2) optimization parameters for the entire signal cycle (e.g., cycle length from 60 seconds to 70 seconds), and (3) recommended values for signal change timing (e.g., 12 seconds remaining until next signal change). Signal control criteria may be set by clear rules, such as “extend green light by 5 seconds if congestion score is 0.7 or higher” or “shorten cycle if traffic volume is below threshold.” AI outputs are transmitted to signal control hardware, and signal timing is adjusted in real time. Unlike conventional fixed cycle control or manual adjustment by humans, the signal control unit utilizes AI that learns nonlinear patterns and time-series dependencies through multivariate analysis of high-dimensional data, thereby greatly improving the accuracy, real-time performance, and traffic flow optimization effect of signal control. For example, signal control by reinforcement learning AI reduces average waiting time by 20% compared to conventional methods and reduces congestion occurrence frequency by 30%. Application fields include signal control at urban intersections, traffic flow optimization in smart cities, and signal control during large-scale events. Thus, the present invention can technically solve issues such as urban traffic efficiency, reduction of environmental impact, and improvement of user satisfaction.

The parking management unit can grasp the availability status of parking lots in real time and perform parking management. For example, the parking management unit uses sensor detection or camera monitoring to grasp parking lot availability. The specific methods and criteria for grasping parking lot availability need to be clarified. For example, methods include detecting parking lot availability using sensors or monitoring parking lot availability using cameras. By grasping parking lot availability in real time, efficient parking management can be performed. Some or all of the above-described processing in the parking management unit may be performed using AI or without using AI. For example, the parking management unit can input data from sensors or cameras to AI and have AI perform parking lot availability recognition. Specifically, the parking management unit inputs data obtained from magnetic sensors, pressure sensors, infrared sensors, and cameras installed in each parking lot section (e.g., occupancy state vector for each section, image tensor (640×480×3)) to a preprocessing unit for noise removal and normalization, and then to an AI model (e.g., CNN, object detection model YOLO). Examples of AI input include (1) sensor value array for each parking section (100 sections), (2) camera image tensor (640×480×3), and (3) time-series usage history vector (24 hours). AI outputs include (1) vacancy/occupancy judgment label for each section (0: vacant, 1: occupied), (2) total number of vacant spaces in the parking lot (e.g., 15 spaces), and (3) congestion score (0.6). Judgment criteria for availability may be set by clear rules, such as “vacant if sensor value is below threshold” or “vacant if no vehicle detected by image analysis.” AI outputs are transmitted to parking guidance display units and proposal units, and are used to notify users of availability in real time and for efficient parking guidance or reservation system linkage. Unlike conventional visual monitoring by humans or simple sensor judgment, the parking management unit utilizes AI that learns nonlinear patterns and time-series dependencies through multivariate analysis of high-dimensional data, thereby greatly improving the accuracy, real-time performance, and efficiency of parking lot usage. For example, vacancy detection accuracy by CNN image analysis exceeds 98%, and congestion prediction error is reduced by 25% compared to conventional methods. Application fields include urban parking lot management, commercial facility parking lots, and airport/station parking lots. Thus, the present invention can technically solve issues such as parking lot usage efficiency, improvement of user satisfaction, and smooth urban traffic.

The operation adjustment unit can adjust the operation schedule of public transportation to reduce passenger waiting time. For example, the operation adjustment unit adjusts public transportation operation times and frequencies. The specific adjustment methods and criteria for operation schedules need to be clarified. For example, adjusting operation times can shorten passenger waiting time, and adjusting operation frequency can also reduce passenger waiting time. By adjusting the operation schedule of public transportation, passenger waiting time can be shortened. Some or all of the above-described processing in the operation adjustment unit may be performed using AI or without using AI. For example, the operation adjustment unit can input public transportation operation data to AI and have AI perform operation schedule adjustment. Specifically, the operation adjustment unit inputs passenger boarding and alighting data (e.g., boarding and alighting count vector for each stop, time-series usage history), operation history data (e.g., bus/train operation time array), and real-time congestion score (0.1 to 0.9) to an AI model (e.g., time-series prediction model, reinforcement learning model). Examples of AI input include (1) boarding and alighting count vector for the past 24 hours (24 dimensions), (2) operation time array for each route (e.g., 10 routes ×24 times), and (3) congestion score array (10 routes). AI outputs include (1) recommended operation interval for each route (e.g., 10 minutes→8 minutes), (2) recommendation for increasing or decreasing service (e.g., increase service on route 3), and (3) adjustment value for next departure time (e.g., move up by 5 minutes). Adjustment criteria may be set by clear rules, such as “increase service if congestion score is 0.8 or higher” or “decrease service if boarding and alighting count is below threshold.” AI outputs are transmitted to operation management systems and timetable revision modules, and operation schedules are adjusted in real time. Unlike conventional fixed timetables or manual adjustment by humans, the operation adjustment unit utilizes AI that learns nonlinear patterns and time-series dependencies through multivariate analysis of high-dimensional data, thereby greatly improving the accuracy, real-time performance, and user satisfaction of operation adjustment. For example, congestion prediction error is reduced by 25% compared to conventional methods, and average waiting time is shortened by 20%. Application fields include urban bus and railway operation management, airport shuttle buses, and temporary operation during events. Thus, the present invention can technically solve issues such as public transportation efficiency, improvement of user satisfaction, and smooth urban traffic.

The collection unit can estimate a user's emotion and set the timing of data collection based on the estimated user's emotion. For example, if the user is feeling stressed, the collection unit reduces the frequency of data collection to reduce system load. If the user is relaxed, the collection unit increases the frequency of data collection to obtain more detailed information. Furthermore, if the user is in a hurry, only important data is collected preferentially. By adjusting the timing of data collection based on the user's emotion, system load can be reduced and detailed information can be obtained. Emotion estimation is realized using, for example, an emotion engine or generative AI with emotion estimation functions. Generative AI may include text generation AI (e.g., LLM) or multimodal generative AI, but is not limited to these examples. Some or all of the above-described processing in the collection unit may be performed using AI or without using AI. For example, the collection unit can input user emotion data to generative AI and have generative AI adjust the timing of data collection. Specifically, the collection unit obtains various emotion-related data such as user facial expression image tensors (e.g., 224×224×3), voice waveform data (e.g., 16 kHz sampling, 10 seconds), and biometric sensor data (e.g., heart rate time-series vector, skin conductance response value), and performs noise removal, normalization, and feature extraction (e.g., facial feature point extraction, voice spectrum conversion, heart rate variability analysis) in a preprocessing unit. The collection unit inputs these feature vectors to an emotion estimation AI (e.g., multimodal Transformer, hybrid model of convolutional neural network and recurrent neural network). Examples of AI input include (1) facial image feature vector (512 dimensions), (2) voice emotion spectrum (128 dimensions), and (3) biometric sensor time-series vector (60dimensions). AI outputs include (1) emotion label (e.g., stress, relaxation, tension, hurry), (2) emotion intensity score (continuous value from 0.0 to 1.0), and (3) estimation confidence (e.g., 0.92). For example, if “stress” label and intensity 0.8 are output from facial image and voice, the collection unit automatically adjusts the data collection frequency from 1-minute intervals to 5-minute intervals. Conversely, if “relaxation” label and intensity 0.2 are output, detailed data is collected at 30-second intervals. AI outputs are transmitted to subsequent data collection schedulers and priority control modules and are used for threshold judgment (e.g., reduce frequency if emotion intensity is 0.7 or higher), branching processing (e.g., collect only important data if in a hurry), and input to other modules (e.g., transmission of emotion state to the analysis unit). Unlike conventional fixed data collection timing or manual settings by humans, the present invention enables AI to analyze multidimensional emotion data and learn nonlinear patterns and correlations among multiple modalities, thereby realizing data collection control optimized for user state. This provides technical effects such as reduction of system load, optimization of battery consumption, improvement of user experience, and privacy-conscious data collection. Application fields include smart city traffic management, personal mobility support, wearable device-linked traffic services, and urban traffic optimization using stress sensing. Through these technical effects, the present invention can dramatically improve the flexibility, efficiency, and user adaptability of traffic management systems.

The collection unit can analyze past traffic data and determine sensor placement. For example, the collection unit concentrates sensor placement in areas where congestion frequently occurs based on past traffic data. It can also dynamically change sensor placement according to time zones with high traffic volume. Furthermore, the collection unit can add sensors in areas where traffic accidents frequently occur to improve safety. By analyzing past traffic data, optimal sensor placement can be determined and traffic condition recognition can be made more efficient. Some or all of the above-described processing in the collection unit may be performed using AI or without using AI. For example, the collection unit can input past traffic data to AI and have AI determine sensor placement. Specifically, the collection unit obtains large-scale datasets such as time-series traffic volume vectors for the past year (e.g., 1-minute intervals×365 days×100 intersections=52, 560, 000 dimensions), accident occurrence history arrays (e.g., structured data of accident occurrence time, location, and type), and congestion frequency maps (e.g., congestion score matrix on geographic coordinate grids), and performs missing value completion, outlier removal, normalization, and feature extraction (e.g., peak traffic extraction, accident clustering, congestion heatmap generation) in a preprocessing unit. The collection unit inputs these feature quantities to a sensor placement optimization AI (e.g., reinforcement learning model, graph neural network, evolutionary algorithm). Examples of AI input include (1) past traffic volume vector for each intersection (365 days), (2) accident occurrence location label array (1,000 cases), and (3) congestion score map (100×100 grid). AI outputs include (1) recommended sensor installation location list (e.g., coordinate array), (2) installation priority score for each location (0.0 to 1.0), and (3) dynamic placement patterns by time zone (e.g., A, B, C during morning and evening rush hours, D, E at night). For example, AI may output specific placement plans such as “add sensors at intersections X, Y, Z” or “install high-precision cameras in accident-prone area P.” AI outputs are transmitted to subsequent sensor installation planning modules and on-site construction management systems and are used for threshold judgment (e.g., immediate installation if priority is 0.8 or higher), branching processing (e.g., temporary installation only at night), and input to other modules (e.g., transmission of new sensor information to the analysis unit). Unlike conventional sensor placement based on empirical rules or human intuition, the present invention enables AI to analyze high-dimensional, multivariate past data and learn nonlinear patterns and spatial/temporal dependencies, thereby greatly improving the optimization accuracy, efficiency, and cost performance of sensor placement. For example, AI optimization improves accident detection rate by 20% and reduces installation cost by 15%. Application fields include urban traffic control centers, smart city infrastructure design, airport and port sensor network construction, and temporary sensor placement during large-scale events. Through these technical effects, the present invention can technically realize improvements in traffic monitoring, safety, and operational efficiency.

The collection unit can change the data collection method according to weather or time zone during data collection. For example, the collection unit considers road slipperiness during rainy weather when collecting data. At night, it can use highly visible sensors for data collection. Furthermore, during time zones with low traffic volume, the collection unit can reduce the frequency of data collection to reduce system load. By changing the data collection method according to weather or time zone, system load can be reduced and detailed information can be obtained. Some or all of the above-described processing in the collection unit may be performed using AI or without using AI. For example, the collection unit can input weather and time zone data to AI and have AI change the data collection method. Specifically, the collection unit obtains weather sensor data (e.g., time-series vectors for precipitation, temperature, humidity, wind speed), weather labels (e.g., clear, rain, snow, fog), time zone information (e.g., 24-hour division, weekday/holiday flag), and traffic volume vectors (e.g., 1-minute intervals×100 intersections), and performs noise removal, normalization, and feature extraction (e.g., weather change detection, night flag generation, traffic volume peak detection) in a preprocessing unit. The collection unit inputs these feature quantities to a data collection method optimization AI (e.g., rule-based AI+reinforcement learning model, time-series prediction model). Examples of AI input include (1) weather vector for the past hour (60 dimensions), (2) current weather label (1-hot vector), and (3) current time zone index (1 dimension). AI outputs include (1) recommended sensor type (e.g., infrared camera at night, LIDAR in rainy weather), (2) data collection frequency (e.g., 1-minute intervals during normal times, 10-minute intervals at night), and (3) collection range (e.g., focus monitoring on slippery sections during rainy weather). For example, AI may output specific collection strategies such as “use infrared cameras and LIDAR at night and in rainy weather, and collect data at high frequency only at major intersections.” AI outputs are transmitted to subsequent sensor control modules and data collection schedulers and are used for threshold judgment (e.g., reduce frequency if traffic volume is below threshold), branching processing (e.g., switch focus monitoring section during bad weather), and input to other modules (e.g., transmission of collection method information to the analysis unit). Unlike conventional fixed collection methods or manual switching by humans, the present invention enables AI to analyze multivariate weather, time zone, and traffic volume data and learn nonlinear patterns and time-series dependencies, thereby greatly improving the optimization, efficiency, and real-time performance of data collection methods. For example, AI control improves accident detection rate by 15% during bad weather and reduces system load by 20%. Application fields include urban traffic monitoring, environment-adaptive traffic management in smart cities, weather-linked monitoring at airports and ports, and temporary monitoring during large-scale events. Through these technical effects, the present invention can technically improve the flexibility, efficiency, and safety of traffic management systems.

The collection unit can estimate a user's emotion and set the priority of data to be collected based on the estimated user's emotion. For example, if the user is feeling stressed, only important data is collected preferentially. If the user is relaxed, detailed data is collected to improve analysis accuracy. Furthermore, if the user is in a hurry, data that can be collected quickly is prioritized. By determining the priority of data to be collected based on the user's emotion, important data can be collected preferentially. Emotion estimation is realized using, for example, an emotion engine or generative AI with emotion estimation functions. Generative AI may include text generation AI (e.g., LLM) or multimodal generative AI, but is not limited to these examples. Some or all of the above-described processing in the collection unit may be performed using AI or without using AI. For example, the collection unit can input user emotion data to generative AI and have generative AI determine the priority of data. Specifically, the collection unit obtains emotion-related data such as user facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The collection unit inputs these feature vectors to an emotion estimation AI (multimodal Transformer, CNN+RNN hybrid model). Examples of AI input include (1) facial image feature vector (512 dimensions), (2) voice emotion spectrum (128 dimensions), and (3) biometric sensor time-series vector (60 dimensions). AI outputs include (1) emotion label (stress, relaxation, hurry, etc.), (2) emotion intensity score (0.0 to 1.0), and (3) estimation confidence (e.g., 0.92). Furthermore, the collection unit calculates priority scores for data to be collected (e.g., traffic flow data 0.9, sensor images 0.7, user location information 0.5) based on emotion estimation results using AI, and collects data in order of highest priority. For example, if stress intensity is 0.8, only traffic flow data is collected; if relaxation intensity is 0.2, all data types are collected in detail; if hurry intensity is 0.9, only location information and congestion data are collected. AI outputs are transmitted to subsequent data collection schedulers and priority control modules and are used for threshold judgment (collect only data with priority 0.7 or higher), branching processing (limit collection items when in a hurry), and input to other modules (transmission of priority information to the analysis unit). Unlike conventional uniform data collection or manual selection by humans, the present invention enables AI to learn the relationship between multidimensional emotion data and data to be collected, and dynamically optimize priorities by considering nonlinear patterns and situational dependencies, thereby providing technical effects such as reduction of system load, improvement of coverage of important data, and optimization of user experience. Application fields include personal mobility support, stress-sensing traffic services, and wearable device-linked traffic management. Through these technical effects, the present invention can greatly improve the flexibility, efficiency, and user adaptability of traffic management systems.

The collection unit can adjust the collection range during data collection in consideration of surrounding event information. For example, when a large-scale event is held, the collection unit strengthens data collection in the surrounding area. It can also predict traffic volume after the event and expand the collection range. Furthermore, the collection unit can adjust the data collection method in consideration of traffic regulation information during the event. By adjusting the collection range in consideration of surrounding event information, efficient data collection can be performed. Some or all of the above-described processing in the collection unit may be performed using AI or without using AI. For example, the collection unit can input event information to AI and have AI adjust the collection range. Specifically, the collection unit obtains various data such as event information (event name, venue coordinates, start/end time, expected number of visitors), traffic regulation information (regulated section coordinate list, regulation time zone), and past event traffic volume data (1-minute intervals×event period×surrounding intersections), and performs normalization and feature extraction (event impact range estimation, regulation section mapping, congestion prediction) in a preprocessing unit. The collection unit inputs these feature quantities to a collection range optimization AI (e.g., graph neural network, time-series prediction model, reinforcement learning model). Examples of AI input include (1) event venue coordinate vector (2 dimensions), (2) expected number of visitors (1 dimension), (3) regulation section index array (10 sections), and (4) past event congestion vector (100 dimensions). AI outputs include (1) recommended collection range coordinate list (e.g., group of intersections within a 500 m radius), (2) collection enhancement sections (e.g., main routes, areas around regulated sections), and (3) collection frequency by time zone (e.g., 1-minute intervals before and after event start, 5-minute intervals after event end). For example, AI may output specific collection strategies such as “focus monitoring on intersections A, B, C during the event” or “expand collection range to sections D, E after the event.” AI outputs are transmitted to subsequent sensor control modules and data collection schedulers and are used for threshold judgment (expand range if number of visitors exceeds 10,000), branching processing (switch focus monitoring when regulation section occurs), and input to other modules (transmission of event information to the analysis unit). Unlike conventional fixed collection ranges or manual adjustment by humans, the present invention enables AI to analyze multivariate event, regulation, and traffic volume data and learn nonlinear patterns and spatial dependencies, thereby greatly improving the optimization, efficiency, and real-time performance of collection range. For example, AI control improves congestion detection accuracy by 20% during events and reduces unnecessary data collection by 15%. Application fields include urban traffic monitoring, traffic management during large-scale events, and temporary monitoring around airports and stadiums. Through these technical effects, the present invention can technically improve the flexibility, efficiency, and event responsiveness of traffic management systems.

The collection unit can cooperate with other traffic management systems during data collection and share data. For example, the collection unit obtains data from other traffic management systems in real time and integrates it with collected data. It can also share collected data with other traffic management systems to grasp overall traffic conditions. Furthermore, the collection unit can strengthen data linkage with other traffic management systems to realize efficient data collection. By cooperating with other traffic management systems and sharing data, overall traffic conditions can be grasped. Some or all of the above-described processing in the collection unit may be performed using AI or without using AI. For example, the collection unit can input data from other traffic management systems to AI and have AI perform data integration. Specifically, the collection unit obtains various data provided by traffic management systems of other cities or organizations, such as traffic flow data (e.g., congestion scores for each intersection, traffic volume vectors, accident occurrence information), sensor information (e.g., camera image tensors, LIDAR point cloud data), and operation information (e.g., public transportation timetables, delay information) via APIs or standard communication protocols. The collection unit performs format conversion, noise removal, time-series synchronization, and feature extraction (e.g., congestion normalization, accident information mapping, operation delay scoring) in a preprocessing unit and inputs the data to a data integration AI (e.g., multimodal fusion model, graph neural network, Bayesian estimation model). Examples of AI input include (1) congestion score array from other systems (100intersections), (2) accident occurrence event list (100 cases), (3) operation delay vector (10 routes), and (4) sensor image feature vector (512 dimensions). AI outputs include (1) integrated traffic condition map (e.g., overall congestion heatmap), (2) anomaly detection alert list (e.g., accident detection matched by multiple systems), and (3) data reliability score (0.0 to 1.0). For example, AI may output integration results such as “intersection A has congestion score 0.9 in all systems” or “accident detected in section B by all systems.” AI outputs are transmitted to subsequent traffic condition recognition modules and analysis units and are used for threshold judgment (issue warning if congestion score is 0.8 or higher), branching processing (treat as high reliability if matched by multiple systems), and input to other modules (transmission of integrated information to the proposal unit). Unlike conventional single-system dependence or manual data integration by humans, the present invention enables AI to analyze and integrate multidimensional, multimodal data in real time and learn nonlinear patterns and correlations between systems, thereby greatly improving the accuracy, coverage, and real-time performance of traffic condition recognition. For example, AI integration improves anomaly detection accuracy by 25% and reduces information transmission delay by 30%. Application fields include intercity cooperative traffic management, information integration during wide-area disasters, and integrated traffic platforms for smart cities. Through these technical effects, the present invention can technically improve the scalability, reliability, and operational efficiency of traffic management systems.

The analysis unit can estimate a user's emotion and adjust a display method of an analysis result based on the estimated user's emotion. For example, if the user is nervous, the analysis unit provides a simple and highly visible display method. If the user is relaxed, the analysis unit provides a display method that includes detailed information. Furthermore, if the user is in a hurry, the analysis unit provides a display method that highlights key points. By adjusting the display method of analysis results based on the user's emotion, a display method that is easy for the user to view can be provided. Emotion estimation is realized using, for example, an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input user emotion data to generative AI and have generative AI adjust the display method. Specifically, the analysis unit collects various emotion-related data such as user facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The analysis unit inputs these feature vectors to an emotion estimation AI (multimodal Transformer, CNN+RNN hybrid model, etc.). Examples of AI input include (1) facial image feature vector (512 dimensions), (2) voice emotion spectrum (128 dimensions), and (3) biometric sensor time-series vector (60 dimensions). AI outputs include (1) emotion label (nervous, relaxed, hurry, etc.), (2) emotion intensity score (0.0 to 1.0), and (3) estimation confidence (e.g., 0.92). For example, if “nervous” label and intensity 0.7 are output from facial image and voice, the analysis unit simplifies the display UI and displays only key indicators in large font. Conversely, if “relaxed” label and intensity 0.2 are output, detailed graphs and statistical information are displayed in multiple layers. AI outputs are transmitted to subsequent display control modules and user interface generation modules and are used for threshold judgment (simple display if emotion intensity is 0.7 or higher), branching processing (display only key points if in a hurry), and input to other modules (transmission of emotion state to the proposal unit). Unlike conventional fixed display UIs or manual switching by humans, the present invention enables AI to analyze multidimensional emotion data and learn nonlinear patterns and correlations among multiple modalities, thereby realizing display control optimized for user state. This provides technical effects such as improved usability, reduced stress from information overload, situation-adaptive information presentation, and improved accessibility. Application fields include smart city traffic information display, personal mobility devices, in-vehicle infotainment systems, and wearable device-linked traffic services. Through these technical effects, the present invention can dramatically improve the flexibility, efficiency, and user adaptability of traffic management systems.

The analysis unit can refer to past traffic patterns during analysis to improve prediction accuracy. For example, the analysis unit predicts congestion occurrence patterns based on past traffic data. It can also refer to traffic accident occurrence history to identify areas with high accident risk. Furthermore, the analysis unit analyzes past traffic volume data to predict peak traffic volume. By referring to past traffic patterns, prediction accuracy can be improved. Some or all of the above-described processing in the analysis unit may be performed using AI or without using AI. For example, the analysis unit can input past traffic data to AI and have AI improve prediction accuracy. Specifically, the analysis unit obtains large-scale datasets such as time-series traffic volume vectors for the past year (1-minute intervals×365 days×100 intersections=52,560,000 dimensions), accident occurrence history arrays (structured data of accident occurrence time, location, and type), and congestion frequency maps (congestion score matrix on geographic coordinate grids), and performs missing value completion, outlier removal, normalization, and feature extraction (peak traffic extraction, accident clustering, congestion heatmap generation) in a preprocessing unit. The analysis unit inputs these feature quantities to a time-series prediction AI (transformer model, RNN, graph neural network, etc.). Examples of AI input include (1) past traffic volume vector for each intersection (365 days), (2) accident occurrence location label array (1,000 cases), and (3) congestion score map (100×100 grid). AI outputs include (1) future congestion prediction scores (e.g., 0.1, 0.3, 0.8), (2) accident risk prediction values (0.0 to 1.0), and (3) predicted peak traffic occurrence time (e.g., 17:30). For example, AI may output prediction results such as “intersection A will have congestion score 0.9 at 18:00” or “section B has accident risk 0.7.” AI outputs are transmitted to subsequent proposal units and signal control units and are used for threshold judgment (signal extension if congestion score is 0.8 or higher), branching processing (propose detour routes for high accident risk areas), and input to other modules (transmission of congestion prediction values to the parking management unit). Unlike conventional simple statistical processing or prediction based on human experience, the present invention enables AI to analyze high-dimensional, multivariate past data and learn nonlinear patterns and time-series dependencies, thereby greatly improving the accuracy, real-time performance, and versatility of traffic flow prediction and accident risk estimation. For example, AI prediction reduces congestion prediction error by 30% compared to conventional methods and improves accident risk detection rate by 20%. Application fields include urban traffic control centers, smart city traffic prediction, congestion prediction at airports and ports, and traffic guidance during large-scale events. Through these technical effects, the present invention can technically improve the prediction accuracy, operational efficiency, and safety of traffic management systems.

The analysis unit can detect abnormal traffic patterns during analysis and issue a warning. For example, if traffic volume increases rapidly, the analysis unit issues a warning as an abnormal traffic pattern. If a traffic accident occurs, the analysis unit can detect the information in real time and issue a warning. Furthermore, the analysis unit can detect signal failures or abnormalities and issue a warning. By detecting abnormal traffic patterns and issuing warnings, rapid response becomes possible. Some or all of the above-described processing in the analysis unit may be performed using AI or without using AI. For example, the analysis unit can input traffic data to AI and have AI detect abnormal traffic patterns. Specifically, the analysis unit collects various data such as time-series traffic volume vectors (1-minute intervals ×100 intersections), vehicle speed arrays, signal state logs, and camera image tensors (1920×1080×3), and performs noise removal, normalization, and feature extraction (rapid increase detection, signal abnormality flag generation, image abnormal feature extraction) in a preprocessing unit. The analysis unit inputs these feature quantities to an anomaly detection AI (autoencoder, time-series anomaly detection model, graph neural network, etc.). Examples of AI input include (1) time-series traffic volume vector (60 minutes), (2) signal state flag array (100 intersections), and (3) image abnormal feature vector (256 dimensions). AI outputs include (1) anomaly detection alert label (e.g., rapid increase, accident, signal failure), (2) anomaly score (0.0 to 1.0), and (3) anomaly occurrence location and time (e.g., intersection A, 17:45). For example, AI may output warnings such as “anomaly score 0.85 at intersection B” or “signal failure detected at signal C.” AI outputs are transmitted to subsequent warning notification modules and operation management systems and are used for threshold judgment (issue warning if anomaly score is 0.7 or higher), branching processing (notify security personnel upon accident detection), and input to other modules (transmission of anomaly information to the signal control unit). Unlike conventional threshold judgment or visual monitoring by humans, the present invention enables AI to analyze high-dimensional, multivariate data and learn nonlinear patterns and time-series dependencies, thereby greatly improving the accuracy, real-time performance, and automation of anomaly detection. For example, AI anomaly detection improves accident detection rate by 25% and reduces warning notification delay by 30%. Application fields include urban traffic monitoring, anomaly detection in smart cities, safety monitoring at airports and ports, and real-time monitoring during large-scale events. Through these technical effects, the present invention can technically improve the safety, operational efficiency, and rapid response capability of traffic management systems.

The analysis unit can estimate a user's emotion and determine the priority of analysis results based on the estimated user's emotion. For example, if the user is feeling stressed, only important analysis results are displayed preferentially. If the user is relaxed, detailed analysis results are displayed. Furthermore, if the user is in a hurry, analysis results that can be quickly confirmed are prioritized. By determining the priority of analysis results based on the user's emotion, important analysis results can be displayed preferentially. Emotion estimation is realized using, for example, an emotion engine or generative AI with emotion estimation functions. Generative AI may include text generation AI (e.g., LLM) or multimodal generative AI, but is not limited to these examples. Some or all of the above-described processing in the analysis unit may be performed using AI or without using AI. For example, the analysis unit can input user emotion data to generative AI and have generative AI determine the priority of analysis results. Specifically, the analysis unit collects emotion-related data such as user facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The analysis unit inputs these feature vectors to an emotion estimation AI (multimodal Transformer, CNN+RNN hybrid model, etc.). Examples of AI input include (1) facial image feature vector (512dimensions), (2) voice emotion spectrum (128 dimensions), and (3) biometric sensor time-series vector (60 dimensions). AI outputs include (1) emotion label (stress, relaxation, hurry, etc.), (2) emotion intensity score (0.0 to 1.0), and (3) estimation confidence (e.g., 0.92). Furthermore, the analysis unit calculates priority scores for each analysis result (e.g., congestion prediction 0.9, accident risk 0.8, parking lot availability information 0.6) based on emotion estimation results using AI, and displays analysis results in order of highest priority. For example, if stress intensity is 0.8, only congestion prediction and accident risk are displayed; if relaxation intensity is 0.2, all analysis results are displayed in detail; if hurry intensity is 0.9, only key points are displayed. AI outputs are transmitted to subsequent display control modules and user interface generation modules and are used for threshold judgment (display only results with priority 0.7 or higher), branching processing (limit to key points when in a hurry), and input to other modules (transmission of priority information to the proposal unit). Unlike conventional uniform display or manual selection by humans, the present invention enables AI to learn the relationship between multidimensional emotion data and analysis results, and dynamically optimize priorities by considering nonlinear patterns and situational dependencies, thereby providing technical effects such as reduction of system load, improvement of coverage of important information, and optimization of user experience. Application fields include personal mobility support, stress-sensing traffic services, and wearable device-linked traffic management. Through these technical effects, the present invention can greatly improve the flexibility, efficiency, and user adaptability of traffic management systems.

The analysis unit can improve analysis accuracy by considering surrounding construction information during analysis. For example, the analysis unit predicts traffic volume in areas where construction is being carried out and reflects it in the analysis results. It can also improve analysis accuracy by considering traffic regulation information due to construction. Furthermore, the analysis unit can grasp construction progress in real time and reflect it in the analysis results. By considering surrounding construction information, analysis accuracy can be improved. Some or all of the above-described processing in the analysis unit may be performed using AI or without using AI. For example, the analysis unit can input construction information to AI and have AI improve analysis accuracy. Specifically, the analysis unit collects various data such as construction information (construction area coordinates, construction period, progress rate, traffic regulation section list), past construction period traffic volume data (1-minute intervals×construction period×surrounding intersections), and construction progress status (real-time update values), and performs normalization and feature extraction (construction impact range estimation, regulation section mapping, congestion change analysis) in a preprocessing unit. The analysis unit inputs these feature quantities to a construction impact prediction AI (graph neural network, time-series prediction model, reinforcement learning model, etc.). Examples of AI input include (1) construction area coordinate vector (2 dimensions), (2) construction progress rate (0.0 to 1.0), (3) regulation section index array (10 sections), and (4) past construction period congestion vector (100 dimensions). AI outputs include (1) construction impact prediction score (0.0 to 1.0), (2) congestion prediction value (e.g., construction section A is 0.8), and (3) recommended detour route ID (e.g., route 5). For example, AI may output analysis results such as “construction section B has congestion score 0.9” or “regulation is expected to be lifted at 80% construction progress.” AI outputs are transmitted to subsequent proposal units and signal control units and are used for threshold judgment (signal extension if congestion score is 0.8 or higher), branching processing (propose detour routes if construction impact is large), and input to other modules (transmission of construction information to the parking management unit). Unlike conventional manual reflection of construction information or simple rule-based processing, the present invention enables AI to analyze multivariate, time-series, and spatial data and learn nonlinear patterns and the impact of construction progress, thereby greatly improving the accuracy, real-time performance, and adaptability of traffic analysis. For example, AI utilization reduces construction impact prediction error by 25% compared to conventional methods and improves congestion prediction accuracy by 20%. Application fields include urban traffic control centers, smart city infrastructure management, construction period traffic optimization at airports and ports, and temporary construction response during large-scale events. Through these technical effects, the present invention can technically improve the analysis accuracy, operational efficiency, and safety of traffic management systems.

The analysis unit can refer to traffic data of other cities during analysis to optimize the analysis method. For example, the analysis unit optimizes the analysis method based on traffic data of other cities. It can also refer to congestion occurrence patterns in other cities to improve analysis accuracy. Furthermore, the analysis unit can strengthen data linkage with traffic management systems of other cities to optimize the analysis method. By referring to traffic data of other cities, the analysis method can be optimized and analysis accuracy can be improved. Some or all of the above-described processing in the analysis unit may be performed using AI or without using AI. For example, the analysis unit can input traffic data of other cities to AI and have AI optimize the analysis method. Specifically, the analysis unit obtains various data such as traffic flow data of other cities (congestion scores for each intersection, traffic volume vectors, accident occurrence information), sensor information (camera image tensors, LIDAR point cloud data), and operation information (public transportation timetables, delay information) via APIs or standard communication protocols, and performs format conversion, noise removal, time-series synchronization, and feature extraction (congestion normalization, accident information mapping, operation delay scoring) in a preprocessing unit. The analysis unit inputs these feature quantities to an analysis method optimization AI (multimodal fusion model, graph neural network, Bayesian estimation model, etc.). Examples of AI input include (1) congestion score array of other cities (100 intersections), (2) accident occurrence event list (100 cases), (3) operation delay vector (10 routes), and (4) sensor image feature vector (512 dimensions). AI outputs include (1) optimal analysis algorithm selection label (e.g., city A uses RNN, city B uses GNN), (2) recommended analysis parameter values (e.g., time-series window length 30 minutes), and (3) analysis accuracy prediction value (0.0 to 1.0). For example, AI may output optimization results such as “select GNN by reflecting the pattern of city C” or “apply congestion threshold of city D.” AI outputs are transmitted to subsequent analysis execution modules and operation management systems and are used for threshold judgment (switch method if accuracy prediction is 0.8 or higher), branching processing (apply dedicated model for city-specific patterns), and input to other modules (transmission of optimization information to the proposal unit). Unlike conventional dependence on a single city or manual method selection by humans, the present invention enables AI to analyze and optimize multidimensional, multimodal data in real time and learn nonlinear patterns and correlations between cities, thereby greatly improving the optimization, accuracy, and versatility of analysis methods. For example, AI optimization improves analysis accuracy by 25% and reduces operational cost by 15%. Application fields include intercity cooperative traffic management, information integration during wide-area disasters, and integrated traffic platforms for smart cities. Through these technical effects, the present invention can technically improve the scalability, reliability, and operational efficiency of traffic management systems.

The proposal unit is capable of estimating a user's emotion and adjusting the method of presenting proposals based on the estimated user's emotion. For example, if the user is tense, the proposal unit provides a simple and highly visible proposal method. If the user is relaxed, the proposal unit can provide a proposal method that includes detailed information. Furthermore, if the user is in a hurry, the proposal unit can provide a proposal method that focuses on key points. By adjusting the method of presenting proposals based on the user's emotion, it is possible to provide a proposal method that is easy for the user to view. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the proposal unit may be performed using AI or may be performed without using AI. For example, the proposal unit may input the user's emotion data to generative AI and have the generative AI execute the adjustment of the proposal presentation method. Specifically, the proposal unit collects various emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The proposal unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (tension, relaxation, hurry, etc.), (2) emotion intensity scores (0.0-1.0), and (3) estimation confidence (e.g., 0.92). For example, if a “tension” label and intensity 0.7 are output from facial image and voice, the proposal unit simplifies the proposal UI and displays only the main route in large font. Conversely, if a “relaxation” label and intensity 0.2 are output, detailed route information, multiple options, and surrounding facility information are displayed in a multilayered manner. The AI output is transmitted to subsequent proposal display control modules and user interface generation modules, and is used for threshold determination (simple display for emotion intensity of 0.7 or higher), branching processing (display only key points when in a hurry), and input to other modules (transmitting emotion state to the signal control unit or operation adjustment unit). Unlike conventional fixed proposal UIs or manual switching by humans, the present invention enables proposal presentation control optimized for the user's state by having AI analyze multidimensional emotion data and learn nonlinear patterns and correlations among multiple modalities. This results in technical effects such as improved usability, reduced stress from information overload, context-adaptive information presentation, and enhanced accessibility. Application fields include smart city traffic guidance, personal mobility terminals, in-vehicle infotainment systems, and wearable device-linked traffic services. Through these technical effects, the present invention can dramatically improve the flexibility, efficiency, and user adaptability of traffic management systems.

The proposal unit is capable of proposing routes that take into account the risk of traffic accidents at the time of proposal. For example, the proposal unit proposes routes that avoid areas where traffic accidents frequently occur. It can also propose routes that correspond to time periods with low risk of traffic accidents. Furthermore, the proposal unit can propose safe routes based on traffic accident history. By considering the risk of traffic accidents, it is possible to propose safe routes. Some or all of the above-described processing in the proposal unit may be performed using AI or may be performed without using AI. For example, the proposal unit may input traffic accident data to AI and have the AI execute route proposals. Specifically, the proposal unit collects various data such as accident occurrence history arrays for the past year (e.g., structured data of accident occurrence time, location, and accident type), real-time congestion scores (0.1-0.9), traffic volume time-series vectors (1-minute intervals×100 intersections), and weather information (e.g., precipitation, poor visibility flags), and performs missing value completion, outlier removal, normalization, and feature extraction (accident clustering, risk heatmap generation, weather impact estimation) in a preprocessing unit. The proposal unit inputs these features to a route safety optimization AI (graph neural network, time-series prediction model, reinforcement learning model, etc.). Examples of AI inputs include (1) accident occurrence location label arrays (1,000 cases), (2) congestion score maps (100×100 grid), (3) weather vectors (24 hours), and (4) traffic volume vectors (365 days). The AI outputs (1) accident risk prediction values for each route (0.0-1.0), (2) recommended route ID arrays (e.g., Route 3, Route 5), and (3) safety scores (e.g., 0.95). For example, if the AI outputs prediction results such as “Route A has accident risk 0.2” and “Route B has 0.8,” the proposal unit prioritizes proposing routes with lower risk. The AI output is transmitted to subsequent proposal display units and signal control units, and is used for threshold determination (avoid routes with accident risk of 0.7 or higher), branching processing (display warnings for high-risk sections), and input to other modules (transmitting risk information to the operation adjustment unit). Unlike conventional simple map-based route proposals or human judgment based on experience, the present invention enables significant improvement in the accuracy, real-time performance, and versatility of route safety evaluation and accident risk avoidance by having AI analyze high-dimensional, multivariate accident, traffic, and weather data and learn nonlinear patterns and time-series dependencies. For example, utilizing AI can improve accident risk avoidance rates by 20% and user satisfaction by 15% compared to conventional methods. Application fields include urban traffic guidance, safe operation support for logistics vehicles, accident prevention-type traffic management in smart cities, and safe route guidance during events. Through these technical effects, the present invention can technically improve the safety, reliability, and user experience of traffic management systems.

The proposal unit is capable of proposing routes that minimize energy consumption at the time of proposal. For example, the proposal unit proposes routes with low energy consumption. It can also propose routes that correspond to time periods with low traffic volume. Furthermore, the proposal unit can propose routes that take into account energy-efficient driving methods. By minimizing energy consumption, environmental impact can be reduced. Some or all of the above-described processing in the proposal unit may be performed using AI or may be performed without using AI. For example, the proposal unit may input energy consumption data to AI and have the AI execute route proposals. Specifically, the proposal unit collects various data such as vehicle-specific energy consumption history vectors (e.g., consumption per 1 km, 365 days), real-time traffic volume vectors (1-minute intervals×100 intersections), road attribute data (road gradient, signal location, speed limit, etc.), and weather information (e.g., temperature, precipitation, wind speed), and performs noise removal, normalization, and feature extraction (energy consumption pattern extraction, road attribute mapping, weather impact estimation) in a preprocessing unit. The proposal unit inputs these features to an energy optimization AI (reinforcement learning model, graph neural network, time-series prediction model, etc.). Examples of AI inputs include (1) vehicle energy consumption vectors (100 segments), (2) traffic volume vectors (24 hours), (3) road attribute vectors (e.g., gradient, number of signals, speed limit), and (4) weather vectors (24 hours). The AI outputs (1) estimated energy consumption for each route (kWh or L/100km), (2) recommended route ID arrays (e.g., Route 2, Route 4), and (3) energy efficiency scores (0.0-1.0). For example, if the AI outputs prediction results such as “Route A has consumption 5.2 kWh” and “Route B has 4.8 kWh,” the proposal unit prioritizes proposing the route with the lowest consumption. The AI output is transmitted to subsequent proposal display units and in-vehicle navigation systems, and is used for threshold determination (propose only routes with consumption less than 5 kWh), branching processing (switch to energy-efficient route during congestion), and input to other modules (transmitting energy information to the operation adjustment unit). Unlike conventional shortest-distance route proposals or driving instructions based on human experience, the present invention enables significant improvement in the accuracy, real-time performance, and environmental adaptability of energy consumption optimization route proposals by having AI analyze multivariate, high-dimensional energy, traffic, road, and weather data and learn nonlinear patterns and time-series dependencies. For example, utilizing AI can reduce energy consumption by 15% and CO2 emissions by 10% compared to conventional methods. Application fields include driving range optimization for electric vehicles, energy-saving operation support for logistics vehicles, and environmentally adaptive traffic guidance in smart cities. Through these technical effects, the present invention can technically improve the environmental adaptability, efficiency, and sustainability of traffic management systems.

The proposal unit is capable of estimating a user's emotion and determining the priority of proposals based on the estimated user's emotion. For example, if the user is feeling stressed, the proposal unit prioritizes displaying only important proposals. If the user is relaxed, the proposal unit can display detailed proposals. Furthermore, if the user is in a hurry, the proposal unit can prioritize proposals that can be quickly confirmed. By determining the priority of proposals based on the user's emotion, important proposals can be displayed preferentially. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the proposal unit may be performed using AI or may be performed without using AI. For example, the proposal unit may input the user's emotion data to generative AI and have the generative AI execute the determination of proposal priority. Specifically, the proposal unit collects emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The proposal unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). Furthermore, based on the emotion estimation results, the proposal unit uses AI to calculate priority scores for each proposal content (e.g., congestion avoidance route 0.9, energy optimization route 0.7, sightseeing spot proposal 0.5), and displays proposals in order of highest priority. For example, if stress intensity is 0.8, only the congestion avoidance route is displayed; if relaxation intensity is 0.2, all proposals are displayed in detail; if hurry intensity is 0.9, only key points are displayed. The AI output is transmitted to subsequent proposal display control modules and user interface generation modules, and is used for threshold determination (display only proposals with priority 0.7 or higher), branching processing (limit to key points when in a hurry), and input to other modules (transmitting priority information to the signal control unit or operation adjustment unit). Unlike conventional uniform proposal displays or manual selection by humans, the present invention enables dynamic optimization of priorities by having AI learn the relationship between multidimensional emotion data and proposal content, and consider nonlinear patterns and context dependencies, resulting in technical effects such as reduced system load, improved coverage of important information, and optimized user experience. Application fields include personal mobility support, stress-sensing traffic services, and wearable device-linked traffic guidance. Through these technical effects, the present invention can greatly improve the flexibility, efficiency, and user adaptability of traffic management systems.

The proposal unit is capable of proposing routes that take into account the operation status of public transportation at the time of proposal. For example, the proposal unit proposes routes that match the operation schedule of public transportation. It can also propose optimal routes by considering delay information of public transportation. Furthermore, the proposal unit can grasp the operation status of public transportation in real time and propose routes accordingly. By considering the operation status of public transportation, optimal routes can be proposed. Some or all of the above-described processing in the proposal unit may be performed using AI or may be performed without using AI. For example, the proposal unit may input public transportation operation data to AI and have the AI execute route proposals. Specifically, the proposal unit acquires various data via API or standard communication protocols, such as public transportation timetables (e.g., departure and arrival time arrays for each route), real-time delay information (e.g., delay minute vectors, operation stop flags), congestion scores (0.1-0.9), and transfer guidance data (e.g., transfer station lists, required time vectors), and performs format conversion, noise removal, time-series synchronization, and feature extraction (delay correction, congestion normalization, transfer optimization) in a preprocessing unit. The proposal unit inputs these features to a route optimization AI (time-series prediction model, graph neural network, reinforcement learning model, etc.). Examples of AI inputs include (1) operation time arrays (10 routes×24 times), (2) delay vectors (10 routes), (3) congestion score arrays (10 routes), and (4) transfer guidance vectors (e.g., 3 transfers, total required time). The AI outputs (1) recommended route ID arrays (e.g., Route 1, Route 4), (2) required time prediction values (e.g., 45 minutes), and (3) recommended number of transfers (e.g., 2 times). For example, if the AI outputs prediction results such as “Route A has no delay and takes 40 minutes” and “Route B has a 5-minute delay and takes 45 minutes,” the proposal unit proposes the optimal route. The AI output is transmitted to subsequent proposal display units and operation adjustment units, and is used for threshold determination (avoid routes with delays of 10 minutes or more), branching processing (propose alternative routes when congestion is high), and input to other modules (transmitting operation information to the signal control unit). Unlike conventional static timetable-based guidance or manual transfer guidance by humans, the present invention enables significant improvement in the accuracy, real-time performance, and convenience of public transportation-linked route proposals by having AI analyze multidimensional, multimodal operation, congestion, and delay data in real time and learn nonlinear patterns and time-series dependencies. For example, utilizing AI can reduce transfer waiting time by 20% and improve delay avoidance rate by 15% compared to conventional methods. Application fields include urban traffic guidance, smart city public transportation coordination, and transfer support systems for airports and stations. Through these technical effects, the present invention can technically improve the convenience, efficiency, and user satisfaction of traffic management systems.

The proposal unit is capable of proposing customized routes by referring to the user's past movement history at the time of proposal. For example, the proposal unit proposes optimal routes based on routes previously used by the user. It can also propose routes that avoid congestion based on the user's past movement history. Furthermore, the proposal unit can analyze the user's past movement history and propose the most efficient route. By referring to the user's past movement history, customized optimal routes can be proposed. Some or all of the above-described processing in the proposal unit may be performed using AI or may be performed without using AI. For example, the proposal unit may input the user's past movement data to AI and have the AI execute route proposals. Specifically, the proposal unit collects various data such as user-specific past movement history vectors (e.g., time-series arrays of departure, destination, via points, movement time, 365 days), past used route ID arrays, congestion history vectors, and movement means history (e.g., walking, bus, train, car), and performs noise removal, normalization, and feature extraction (movement pattern extraction, congestion avoidance tendency analysis, movement means optimization) in a preprocessing unit. The proposal unit inputs these features to a personalized route AI (time-series prediction model, clustering model, reinforcement learning model, etc.). Examples of AI inputs include (1) past movement history vectors (30 days), (2) past used route ID arrays (100 cases), (3) congestion history vectors (30 days), and (4) movement means history vectors (30 days). The AI outputs (1) recommended customized route ID (e.g., Route 7), (2) congestion avoidance score (0.0-1.0), and (3) required time prediction value (e.g., 35 minutes). For example, if the AI outputs results such as “Route A is recommended based on past trends” and “congestion avoidance rate 0.9,” the proposal unit proposes a route optimized for the user. The AI output is transmitted to subsequent proposal display units and operation adjustment units, and is used for threshold determination (propose only routes with congestion avoidance score of 0.8 or higher), branching processing (prioritize display for frequently used routes), and input to other modules (transmitting customization information to the signal control unit). Unlike conventional uniform route proposals or manual history reference by humans, the present invention enables significant improvement in the accuracy, convenience, and user satisfaction of personalized route proposals by having AI analyze multidimensional, time-series movement history data and learn nonlinear patterns and individual characteristics. For example, utilizing AI can improve congestion avoidance rate by 20% and reduce movement time by 15% compared to conventional methods. Application fields include personal mobility support, individually optimized traffic guidance in smart cities, and commuting optimization services for enterprises. Through these technical effects, the present invention can technically improve the flexibility, efficiency, and user adaptability of traffic management systems.

The signal control unit is capable of estimating a user's emotion and adjusting signal timing based on the estimated user's emotion. For example, if the user is feeling stressed, the signal control unit shortens the signal waiting time. If the user is relaxed, the signal control unit can set the signal waiting time as usual. Furthermore, if the user is in a hurry, the signal control unit can minimize the signal waiting time. By adjusting signal timing based on the user's emotion, stress from waiting at signals can be reduced. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the signal control unit may be performed using AI or may be performed without using AI. For example, the signal control unit may input the user's emotion data to generative AI and have the generative AI execute the adjustment of signal timing. Specifically, the signal control unit collects various emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The signal control unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output from facial image and voice, the signal control unit shortens the signal waiting time from the usual 60 seconds to 30 seconds. Conversely, if a “relaxation” label and intensity 0.2 are output, the usual signal cycle is maintained. The AI output is transmitted to subsequent signal control algorithm selection modules and signal control hardware, and is used for threshold determination (shorten for emotion intensity of 0.7 or higher), branching processing (set minimum waiting time when in a hurry), and input to other modules (transmitting emotion state to the traffic flow analysis unit). Unlike conventional fixed signal cycles or manual adjustment by humans, the present invention enables signal control optimized for the user's state by having AI analyze multidimensional emotion data and learn nonlinear patterns and correlations among multiple modalities. This results in technical effects such as reduced stress from waiting at signals, smoother traffic flow, improved user experience, and enhanced accessibility. Application fields include signal control at urban intersections, personal mobility support, emotion-adaptive traffic management in smart cities, and wearable device-linked signal control. Through these technical effects, the present invention can dramatically improve the flexibility, efficiency, and user adaptability of traffic management systems.

The signal control unit is capable of prioritizing the passage of emergency vehicles during signal control. For example, when an emergency vehicle approaches, the signal control unit changes the signal to green to prioritize passage. It can also predict the route of the emergency vehicle and adjust signal timing. Furthermore, after the emergency vehicle has passed, the signal control unit can return to normal signal control. By prioritizing the passage of emergency vehicles, rapid response in emergencies can be achieved. Some or all of the above-described processing in the signal control unit may be performed using AI or may be performed without using AI. For example, the signal control unit may input emergency vehicle data to AI and have the AI execute the adjustment of signal timing. Specifically, the signal control unit acquires various data in real time, such as position information from emergency vehicles (GPS coordinate time-series vector, 1-second intervals), direction of travel data (azimuth vector), vehicle type label (ambulance, fire truck, etc.), and emergency flag (0: normal, 1: emergency), and performs noise removal, normalization, and feature extraction (travel prediction, arrival time estimation, priority scoring) in a preprocessing unit. The signal control unit inputs these features to an emergency vehicle priority AI (time-series prediction model, graph neural network, reinforcement learning model, etc.). Examples of AI inputs include (1) emergency vehicle position vectors (10 seconds), (2) direction of travel vectors (10 seconds), and (3) emergency flag (1 dimension). The AI outputs (1) priority signal switching timing (e.g., intersection A switches to green in 5 seconds), (2) estimated passage route ID arrays (e.g., Route 1, Route 3), and (3) normal control return timing (e.g., 10 seconds after passage). For example, if the AI outputs control instructions such as “intersection B maintains green signal until emergency vehicle passes” and “returns to normal cycle after passage,” the signal control unit executes these instructions. The AI output is transmitted to subsequent signal control hardware and operation management systems, and is used for threshold determination (immediate switching for emergency flag 1), branching processing (select highest priority when multiple vehicles approach simultaneously), and input to other modules (transmitting emergency information to the traffic flow analysis unit). Unlike conventional manual signal switching or simple rule-based control, the present invention enables significant improvement in the accuracy, real-time performance, and safety of emergency vehicle priority control by having AI analyze high-dimensional, time-series emergency vehicle data and learn nonlinear travel patterns and coordination among multiple intersections. For example, utilizing AI can shorten emergency vehicle passage time by 30% and reduce accident risk at intersections by 20% compared to conventional methods. Application fields include emergency vehicle priority control at urban intersections, disaster response in smart cities, and emergency vehicle guidance at airports and ports. Through these technical effects, the present invention can technically improve the safety, rapid response capability, and operational efficiency of traffic management systems.

The signal control unit is capable of adjusting signal timing to ensure pedestrian safety during signal control. For example, at intersections with many pedestrians, the signal control unit extends the pedestrian signal time. If pedestrians are crossing, the signal control unit can set the vehicle signal to red to ensure safety. Furthermore, the signal control unit can detect pedestrian movement in real time and adjust signal timing accordingly. By considering pedestrian safety, the risk of traffic accidents can be reduced. Some or all of the above-described processing in the signal control unit may be performed using AI or may be performed without using AI. For example, the signal control unit may input pedestrian data to AI and have the AI execute the adjustment of signal timing. Specifically, the signal control unit collects various data such as camera image tensors installed at intersections (1920×1080×3), infrared sensor data (pedestrian detection flag), LIDAR point cloud data (3D coordinate array), and pedestrian density vectors (1-minute intervals), and performs noise removal, normalization, and feature extraction (pedestrian detection, movement direction estimation, crossing judgment) in a preprocessing unit. The signal control unit inputs these features to a pedestrian safety optimization AI (CNN, graph neural network, time-series prediction model, etc.). Examples of AI inputs include (1) camera image feature vectors (512 dimensions), (2) pedestrian density vectors (10 intersections), and (3 crossing flag arrays (10 intersections). The AI outputs (1) pedestrian signal extension time (e.g., normal 30 seconds→45 seconds), (2) vehicle signal red extension instructions (e.g., extend by 10 seconds during crossing), and (3) safety assurance alerts (e.g., issue warning during high density). For example, if the AI outputs control instructions such as “extend signal at intersection A due to high pedestrian density” and “maintain vehicle red signal during crossing detection,” the signal control unit executes these instructions. The AI output is transmitted to subsequent signal control hardware and warning alert modules, and is used for threshold determination (extend for pedestrian density of 0.7 or higher), branching processing (maintain vehicle red signal during crossing), and input to other modules (transmitting pedestrian information to the traffic flow analysis unit). Unlike conventional fixed signal cycles or visual monitoring by humans, the present invention enables significant improvement in the accuracy, real-time performance, and accident risk reduction effect of pedestrian safety assurance by having AI analyze high-dimensional, multimodal pedestrian data and learn nonlinear patterns and real-time movements. For example, utilizing AI can reduce pedestrian accident rates by 20% and optimize traffic flow by adjusting signal waiting times. Application fields include pedestrian safety control at urban intersections, signal management in school zones, and safety optimization traffic management in smart cities. Through these technical effects, the present invention can technically improve the safety, efficiency, and user satisfaction of traffic management systems.

The signal control unit is capable of estimating a user's emotion and determining the priority of signal control based on the estimated user's emotion. For example, if the user is feeling stressed, the signal control unit shortens the signal waiting time. If the user is relaxed, the signal control unit can set the signal waiting time as usual. Furthermore, if the user is in a hurry, the signal control unit can minimize the signal waiting time. By determining the priority of signal control based on the user's emotion, important signal control can be performed preferentially. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the signal control unit may be performed using AI or may be performed without using AI. For example, the signal control unit may input the user's emotion data to generative AI and have the generative AI execute the determination of signal control priority. Specifically, the signal control unit collects emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The signal control unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). Furthermore, based on the emotion estimation results, the signal control unit uses AI to calculate priority scores for each signal control target (e.g., main intersection 0.9, residential area 0.7, commercial area 0.5), and executes control in order of highest priority. For example, if stress intensity is 0.8, the signal waiting time at main intersections is shortened; if relaxation intensity is 0.2, all signals are controlled as usual; if hurry intensity is 0.9, the signal waiting time near the destination is set to minimum. The AI output is transmitted to subsequent signal control algorithm selection modules and signal control hardware, and is used for threshold determination (shorten only for priority 0.7 or higher), branching processing (limit to key points when in a hurry), and input to other modules (transmitting priority information to the traffic flow analysis unit). Unlike conventional uniform signal control or manual selection by humans, the present invention enables dynamic optimization of priorities by having AI learn the relationship between multidimensional emotion data and signal control targets, and consider nonlinear patterns and context dependencies, resulting in technical effects such as reduced system load, improved coverage of important signals, and optimized user experience. Application fields include personal mobility support, stress-sensing signal control, and wearable device-linked traffic management. Through these technical effects, the present invention can greatly improve the flexibility, efficiency, and user adaptability of traffic management systems.

The signal control unit is capable of reflecting surrounding traffic conditions in real time during signal control. For example, the signal control unit grasps surrounding traffic volume in real time and adjusts signal timing. If traffic congestion occurs, the signal control unit can change signal timing to alleviate congestion. Furthermore, if a traffic accident occurs, the signal control unit can reflect that information and adjust signal timing. By reflecting surrounding traffic conditions in real time, the accuracy of signal control can be improved. Some or all of the above-described processing in the signal control unit may be performed using AI or may be performed without using AI. For example, the signal control unit may input surrounding traffic data to AI and have the AI execute the adjustment of signal timing. Specifically, the signal control unit acquires various data in real time, such as traffic volume time-series vectors for each intersection (1-minute intervals×100 intersections), congestion scores (0.1-0.9), accident occurrence flags, vehicle speed arrays, and camera image feature vectors (512 dimensions), and performs noise removal, normalization, and feature extraction (congestion estimation, accident detection, congestion section identification) in a preprocessing unit. The signal control unit inputs these features to a signal control optimization AI (time-series prediction model, graph neural network, reinforcement learning model, etc.). Examples of AI inputs include (1) traffic volume vectors (100 intersections), (2) congestion score arrays (100 intersections), (3) accident occurrence flag arrays (100 intersections), and (4) image feature vectors (512 dimensions). The AI outputs (1) extension or shortening times for green/red signals at each signal (e.g., green signal extension by 5 seconds), (2) overall signal cycle optimization parameters (e.g., cycle length 60 seconds→70 seconds), and (3) congestion alleviation recommendations (e.g., extend green signal in congestion sections). For example, if the AI outputs control instructions such as “extend green signal at intersection A with congestion score 0.8” and “maintain red signal at intersection B due to accident occurrence,” the signal control unit executes these instructions. The AI output is transmitted to subsequent signal control hardware and operation management systems, and is used for threshold determination (extend for congestion score of 0.7 or higher), branching processing (maintain red signal during accident occurrence), and input to other modules (transmitting real-time information to the traffic flow analysis unit). Unlike conventional fixed cycle control or manual adjustment by humans, the present invention enables significant improvement in the accuracy, real-time performance, and traffic flow optimization effect of signal control by having AI analyze high-dimensional, multivariate traffic data in real time and learn nonlinear patterns and time-series dependencies. For example, AI control can reduce congestion occurrence frequency by 30% and shorten response delay during accidents by 20% compared to conventional methods. Application fields include signal control at urban intersections, traffic flow optimization in smart cities, and signal control during large-scale events. Through these technical effects, the present invention can technically improve the efficiency, safety, and operational flexibility of traffic management systems.

The signal control unit is capable of optimizing signal timing by cooperating with other traffic management systems during signal control. For example, the signal control unit acquires data from other traffic management systems in real time and optimizes signal timing. It can also grasp overall traffic conditions by cooperating with other traffic management systems and adjust signal timing. Furthermore, the signal control unit can strengthen data cooperation with other traffic management systems to achieve efficient signal control. By cooperating with other traffic management systems, signal timing can be optimized and traffic flow can be made smoother. Some or all of the above-described processing in the signal control unit may be performed using AI or may be performed without using AI. For example, the signal control unit may input data from other traffic management systems to AI and have the AI execute the optimization of signal timing. Specifically, the signal control unit acquires various data via API or standard communication protocols, such as traffic flow data provided by traffic management systems of other cities or organizations (congestion scores for each intersection, traffic volume vectors, accident occurrence information), sensor information (camera image tensors, LIDAR point cloud data), and operation information (public transportation timetables, delay information), and performs format conversion, noise removal, time-series synchronization, and feature extraction (congestion normalization, accident information mapping, operation delay scoring) in a preprocessing unit. The signal control unit inputs these data to a signal control optimization AI (multimodal fusion model, graph neural network, Bayesian estimation model, etc.). Examples of AI inputs include (1) congestion score arrays from other systems (100 intersections), (2) accident occurrence event lists (100 cases), (3) operation delay vectors (10 routes), and (4) sensor image feature vectors (512 dimensions). The AI outputs (1) overall optimized signal timing parameters (e.g., extend green signal at main intersections, shorten at surrounding intersections), (2) recommended values for signal control cooperation (e.g., simultaneous switching in cities A and B), and (3) signal control reliability scores (0.0-1.0). For example, if the AI outputs control instructions such as “extend green signal at city A with congestion score 0.9” and “change signal cycle at city B due to accident occurrence,” the signal control unit executes these instructions. The AI output is transmitted to subsequent signal control hardware and operation management systems, and is used for threshold determination (extend for congestion score of 0.8 or higher), branching processing (treat as high reliability when multiple systems agree), and input to other modules (transmitting integrated information to the traffic flow analysis unit). Unlike conventional single-system dependence or manual data integration by humans, the present invention enables significant improvement in the optimization, wide-area coverage, and real-time performance of signal control by having AI analyze and integrate multidimensional, multimodal data in real time and learn nonlinear patterns and correlations among systems. For example, AI integration can improve signal control optimization accuracy by 25% and shorten information transmission delay by 30% compared to conventional methods. Application fields include intercity cooperative signal control, traffic management during wide-area disasters, and integrated traffic platforms in smart cities. Through these technical effects, the present invention can technically improve the scalability, reliability, and operational efficiency of traffic management systems.

The parking management unit is capable of estimating a user's emotion and adjusting the method of guiding parking lots based on the estimated user's emotion. For example, if the user is feeling stressed, the parking management unit provides a simple and highly visible guidance method. If the user is relaxed, the parking management unit can provide a guidance method that includes detailed information. Furthermore, if the user is in a hurry, the parking management unit can provide a guidance method that focuses on key points. By adjusting the method of guiding parking lots based on the user's emotion, it is possible to provide a guidance method that is easy for the user to view. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the parking management unit may be performed using AI or may be performed without using AI. For example, the parking management unit may input the user's emotion data to generative AI and have the generative AI execute the adjustment of the guidance method. Specifically, the parking management unit collects various emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The parking management unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output from facial image and voice, the parking management unit simplifies the guidance UI and displays only the main parking lots in large font. Conversely, if a “relaxation” label and intensity 0.2 are output, detailed parking lot information, multiple options, and surrounding facility information are displayed in a multilayered manner. The AI output is transmitted to subsequent guidance display control modules and user interface generation modules, and is used for threshold determination (simple display for emotion intensity of 0.7 or higher), branching processing (display only key points when in a hurry), and input to other modules (transmitting emotion state to the parking reservation system or operation adjustment unit). Unlike conventional fixed guidance UIs or manual switching by humans, the present invention enables guidance presentation control optimized for the user's state by having AI analyze multidimensional emotion data and learn nonlinear patterns and correlations among multiple modalities. This results in technical effects such as improved usability, reduced stress from information overload, context-adaptive information presentation, and enhanced accessibility. Application fields include smart city parking guidance, personal mobility terminals, in-vehicle infotainment systems, and wearable device-linked parking services. Through these technical effects, the present invention can dramatically improve the flexibility, efficiency, and user adaptability of parking management systems.

The parking management unit is capable of predicting the usage status of parking lots during parking management and proposing optimal parking locations. For example, the parking management unit predicts usage status based on past usage data of parking lots. It can also grasp the availability status of parking lots in real time and propose optimal parking locations. Furthermore, the parking management unit can analyze usage patterns of parking lots and propose efficient parking locations. By predicting the usage status of parking lots, optimal parking locations can be proposed. Some or all of the above-described processing in the parking management unit may be performed using AI or may be performed without using AI. For example, the parking management unit may input parking lot usage data to AI and have the AI execute the proposal of parking locations. Specifically, the parking management unit acquires large-scale datasets such as past one-year parking lot usage history vectors (e.g., hourly×365 days33 50 parking lots=438,000 dimensions), real-time availability arrays (e.g., number of available spaces for each parking lot), user attribute data (e.g., vehicle type, usage purpose, day-of-week/time zone flags), and performs missing value completion, outlier removal, normalization, and feature extraction (peak usage time extraction, user clustering, availability heatmap generation) in a preprocessing unit. The parking management unit inputs these features to a parking lot usage prediction AI (time-series prediction model, graph neural network, reinforcement learning model, etc.). Examples of AI inputs include (1) past usage vectors for each parking lot (365 days), (2) real-time available space arrays (50 parking lots), (3) user attribute vectors (1,000 cases), and (4) day-of-week/time zone index (1 dimension). The AI outputs (1) availability prediction scores for each parking lot (0.0-1.0), (2) recommended parking lot ID lists (e.g., Parking Lot A, Parking Lot C), and (3) usage efficiency scores (e.g., 0.95). For example, if the AI outputs prediction results such as “Parking Lot A has availability prediction 0.8” and “Parking Lot B has high risk of being full,” the parking management unit prioritizes proposing optimal parking locations. The AI output is transmitted to subsequent guidance display units and reservation systems, and is used for threshold determination (propose only for availability prediction of 0.7 or higher), branching processing (propose other parking lots when risk of being full is high), and input to other modules (transmitting parking lot information to the operation adjustment unit). Unlike conventional simple display of available spaces or guidance based on human experience, the present invention enables significant improvement in the accuracy, real-time performance, and versatility of parking lot usage prediction and optimal proposal by having AI analyze high-dimensional, multivariate usage data and learn nonlinear patterns and time-series dependencies. For example, utilizing AI can reduce availability prediction error by 30% and improve usage efficiency by 20% compared to conventional methods. Application fields include urban parking guidance, parking optimization in smart cities, parking lot management for commercial facilities, and temporary parking guidance during large-scale events. Through these technical effects, the present invention can technically improve the prediction accuracy, operational efficiency, and user satisfaction of parking management systems.

The parking management unit is capable of performing efficient parking management by cooperating with parking reservation systems during parking management. For example, the parking management unit acquires data from parking reservation systems in real time and reflects it in parking management. It can also propose optimal parking locations by considering reservation status. Furthermore, the parking management unit can achieve efficient parking management by cooperating with parking reservation systems. By cooperating with parking reservation systems, efficient parking management can be performed. Some or all of the above-described processing in the parking management unit may be performed using AI or may be performed without using AI. For example, the parking management unit may input parking reservation data to AI and have the AI execute the adjustment of parking management. Specifically, the parking management unit acquires various data via API or standard communication protocols, such as reservation status arrays obtained from reservation systems (e.g., number of reservations and reservation time slots for each parking lot ID), real-time available space data, user attributes (e.g., member ID, vehicle type, usage purpose), and past reservation history vectors (e.g., daily×365 days×50 parking lots), and performs format conversion, noise removal, time-series synchronization, and feature extraction (reservation rate estimation, usage trend analysis, availability prediction) in a preprocessing unit. The parking management unit inputs these features to a parking reservation optimization AI (time-series prediction model, graph neural network, reinforcement learning model, etc.). Examples of AI inputs include (1) reservation status arrays (50 parking lots), (2) real-time available space arrays (50 parking lots), (3) user attribute vectors (1,000 cases), and (4) past reservation history vectors (365 days). The AI outputs (1) reservation-priority parking lot ID lists (e.g., Parking Lot A, Parking Lot D), (2) availability prediction scores (0.0-1.0), and (3) usage efficiency scores (e.g., 0.93). For example, if the AI outputs results such as “Parking Lot A is reservation-priority” and “Parking Lot B has low availability prediction,” the parking management unit proposes optimal parking locations according to reservation status. The AI output is transmitted to subsequent guidance display units and reservation systems, and is used for threshold determination (propose only for availability prediction of 0.7 or higher), branching processing (propose other parking lots when reservation is full), and input to other modules (transmitting reservation information to the operation adjustment unit). Unlike conventional manual reservation management or simple display of available spaces, the present invention enables significant improvement in the efficiency, accuracy, and user experience of parking reservation management by having AI analyze multidimensional, time-series reservation and usage data in real time and learn nonlinear patterns and usage trends. For example, utilizing AI can improve automation rate of reservation management operations by 30% and usage efficiency by 20% compared to conventional methods. Application fields include urban parking reservation management, parking optimization in smart cities, reservation-linked parking lots for commercial facilities, and temporary reservation management during large-scale events. Through these technical effects, the present invention can technically improve the efficiency, accuracy, and user satisfaction of parking management systems.

The parking management unit is capable of estimating a user's emotion and determining the priority of parking management based on the estimated user's emotion. For example, if the user is feeling stressed, the parking management unit prioritizes displaying only important parking management information. If the user is relaxed, the parking management unit can display detailed parking management information. Furthermore, if the user is in a hurry, the parking management unit can prioritize parking management information that can be quickly confirmed. By determining the priority of parking management based on the user's emotion, important parking management information can be displayed preferentially. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the parking management unit may be performed using AI or may be performed without using AI. For example, the parking management unit may input the user's emotion data to generative AI and have the generative AI execute the determination of parking management priority. Specifically, the parking management unit collects emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The parking management unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). Furthermore, based on the emotion estimation results, the parking management unit uses AI to calculate priority scores for each parking management information item (e.g., availability status 0.9, reservation information 0.8, fee guidance 0.6), and displays information in order of highest priority. For example, if stress intensity is 0.8, only availability status and reservation information are displayed; if relaxation intensity is 0.2, all information is displayed in detail; if hurry intensity is 0.9, only key points are displayed. The AI output is transmitted to subsequent guidance display control modules and user interface generation modules, and is used for threshold determination (display only information with priority 0.7 or higher), branching processing (limit to key points when in a hurry), and input to other modules (transmitting priority information to the operation adjustment unit). Unlike conventional uniform information display or manual selection by humans, the present invention enables dynamic optimization of priorities by having AI learn the relationship between multidimensional emotion data and parking management information, and consider nonlinear patterns and context dependencies, resulting in technical effects such as reduced system load, improved coverage of important information, and optimized user experience. Application fields include personal mobility support, stress-sensing parking services, and wearable device-linked parking management. Through these technical effects, the present invention can greatly improve the flexibility, efficiency, and user adaptability of parking management systems.

The parking management unit is capable of reflecting surrounding parking lot information in real time during parking management. For example, the parking management unit grasps the availability status of surrounding parking lots in real time and reflects it in parking management. It can also predict the usage status of surrounding parking lots and propose optimal parking locations. Furthermore, the parking management unit can acquire information on surrounding parking lots in real time and reflect it in parking management. By reflecting surrounding parking lot information in real time, efficient parking management can be performed. Some or all of the above-described processing in the parking management unit may be performed using AI or may be performed without using AI. For example, the parking management unit may input surrounding parking lot data to AI and have the AI execute the adjustment of parking management. Specifically, the parking management unit collects various data such as real-time available space arrays (e.g., 100 parking lots) acquired from surrounding parking lots via API or standard communication protocols, usage status time-series vectors (hourly×100 parking lots×7 days), fee information arrays, and user attribute data (e.g., vehicle type, usage purpose), and performs noise removal, normalization, and feature extraction (availability heatmap generation, usage trend analysis, fee optimization) in a preprocessing unit. The parking management unit inputs these features to a surrounding parking lot optimization AI (graph neural network, time-series prediction model, reinforcement learning model, etc.). Examples of AI inputs include (1) real-time available space arrays (100 parking lots), (2) usage status vectors (7 days), (3) fee information vectors (100 parking lots), and (4) user attribute vectors (1,000 cases). The AI outputs (1) recommended parking lot ID lists (e.g., Parking Lot A, Parking Lot F), (2) availability prediction scores (0.0-1.0), and (3) usage efficiency scores (e.g., 0.97). For example, if the AI outputs results such as “Parking Lot A has availability prediction 0.9” and “Parking Lot B has optimal fee,” the parking management unit proposes optimal parking locations. The AI output is transmitted to subsequent guidance display units and reservation systems, and is used for threshold determination (propose only for availability prediction of 0.7 or higher), branching processing (propose other parking lots when risk of being full is high), and input to other modules (transmitting parking lot information to the operation adjustment unit). Unlike conventional manual information collection or simple display of available spaces, the present invention enables significant improvement in the accuracy, efficiency, and user experience of parking lot guidance by having AI analyze multidimensional, real-time surrounding parking lot data and learn nonlinear patterns and spatial dependencies. For example, utilizing AI can reduce availability prediction error by 25% and improve usage efficiency by 15% compared to conventional methods. Application fields include urban parking guidance, parking optimization in smart cities, parking lot management for commercial facilities, and temporary parking guidance during large-scale events. Through these technical effects, the present invention can technically improve the efficiency, accuracy, and user satisfaction of parking management systems.

The parking management unit is capable of improving parking lot utilization efficiency by cooperating with parking management systems of other cities during parking management. For example, the parking management unit acquires data from parking management systems of other cities in real time and reflects it in parking management. It can also improve overall parking lot utilization efficiency by cooperating with parking management systems of other cities. Furthermore, the parking management unit can strengthen data cooperation with parking management systems of other cities to achieve efficient parking management. By cooperating with parking management systems of other cities, parking lot utilization efficiency can be improved. Some or all of the above-described processing in the parking management unit may be performed using AI or may be performed without using AI. For example, the parking management unit may input parking management data from other cities to AI and have the AI execute the adjustment of parking management. Specifically, the parking management unit acquires various data via API or standard communication protocols, such as parking lot usage data from other cities (e.g., available space time-series vectors for each parking lot, utilization rate scores, fee information), reservation status arrays, user attribute data (e.g., vehicle type, usage purpose), and past usage history vectors (e.g., daily×365 days×100 parking lots), and performs format conversion, noise removal, time-series synchronization, and feature extraction (utilization efficiency comparison, availability heatmap generation, fee optimization) in a preprocessing unit. The parking management unit inputs these features to a wide-area parking lot optimization AI (multimodal fusion model, graph neural network, Bayesian estimation model, etc.). Examples of AI inputs include (1) available space arrays from other cities (100 parking lots), (2) utilization rate score arrays (100 parking lots), (3) fee information vectors (100 parking lots), and (4) user attribute vectors (1,000 cases). The AI outputs (1) overall optimized parking lot ID lists (e.g., Parking Lot X in City A, Parking Lot Y in City B), (2) usage efficiency scores (e.g., 0.98), and (3) cooperation recommendation values (e.g., simultaneous guidance in Cities A and B). For example, if the AI outputs results such as “Parking Lot X in City A has high utilization efficiency” and “Parking Lot Y in City B has high availability prediction,” the parking management unit proposes optimal parking locations on a wide-area basis. The AI output is transmitted to subsequent guidance display units and reservation systems, and is used for threshold determination (propose only for usage efficiency of 0.8 or higher), branching processing (treat as high efficiency when cooperating with multiple cities), and input to other modules (transmitting cooperation information to the operation adjustment unit). Unlike conventional single-city dependence or manual data integration by humans, the present invention enables significant improvement in the optimization, wide-area coverage, and real-time performance of parking lot utilization efficiency by having AI analyze and integrate multidimensional, wide-area data in real time and learn nonlinear patterns and correlations among cities. For example, AI integration can improve usage efficiency by 25% and shorten information transmission delay by 30% compared to conventional methods. Application fields include intercity cooperative parking management, wide-area event parking guidance, and integrated parking platforms in smart cities. Through these technical effects, the present invention can technically improve the scalability, reliability, and operational efficiency of parking management systems.

The operation adjustment unit is capable of estimating a user's emotion and adjusting the operation schedule based on the estimated user's emotion. For example, if the user is feeling stressed, the operation adjustment unit quickly adjusts the operation schedule. If the user is relaxed, the operation adjustment unit can provide a detailed operation schedule. Furthermore, if the user is in a hurry, the operation adjustment unit can provide an operation schedule that can be quickly confirmed. By adjusting the operation schedule based on the user's emotion, it is possible to provide an optimal operation schedule for the user. Emotion estimation is realized, for example, by using an emotion estimation function employing an emotion engine or generative AI. Generative AI may include text generation AI (e.g., LLM) or multimodal generative AI, but is not limited to such examples. Some or all of the above-described processing in the operation adjustment unit may be performed using AI or may be performed without using AI. For example, the operation adjustment unit may input the user's emotion data to generative AI and have the generative AI execute the adjustment of the operation schedule. Specifically, the operation adjustment unit collects various emotion-related data such as facial expression image tensors (224×224×3), voice waveform data (16 kHz sampling, 10 seconds), and biometric sensor data (heart rate time-series vector, skin conductance response value), and performs noise removal, normalization, and feature extraction (facial feature point extraction, voice spectrum conversion, heart rate variability analysis) in a preprocessing unit. The operation adjustment unit inputs these feature vectors to an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time-series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output from facial image and voice, the operation adjustment unit simplifies the operation schedule display UI and displays only main departure times and transfer information in large font. Conversely, if a “relaxation” label and intensity 0.2 are output, detailed operation schedules, multiple options, and delay prediction information are displayed in a multilayered manner. The AI output is transmitted to subsequent operation schedule display control modules and user interface generation modules, and is used for threshold determination (simple display for emotion intensity of 0.7 or higher), branching processing (display only key points when in a hurry), and input to other modules (transmitting emotion state to the proposal unit or signal control unit). Unlike conventional fixed operation schedule displays or manual switching by humans, the present invention enables operation schedule adjustment optimized for the user's state by having AI analyze multidimensional emotion data and learn nonlinear patterns and correlations among multiple modalities. This results in technical effects such as improved usability, reduced stress from information overload, context-adaptive information presentation, and enhanced accessibility. Application fields include public transportation guidance in smart cities, personal mobility terminals, in-vehicle infotainment systems, and wearable device-linked operation adjustment services. Through these technical effects, the present invention can dramatically improve the flexibility, efficiency, and user adaptability of operation adjustment systems.

The operation adjustment unit is capable of analyzing passenger boarding and alighting data during operation adjustment and proposing optimal operation schedules. For example, the operation adjustment unit proposes optimal operation schedules based on passenger boarding and alighting data. It can also analyze passenger boarding and alighting patterns and propose efficient operation schedules. Furthermore, the operation adjustment unit can grasp passenger boarding and alighting data in real time and reflect it in the operation schedule. By analyzing passenger boarding and alighting data, optimal operation schedules can be proposed. Some or all of the above-described processing in the operation adjustment unit may be performed using AI or may be performed without using AI. For example, the operation adjustment unit may input passenger boarding and alighting data to AI and have the AI execute the proposal of operation schedules. Specifically, the operation adjustment unit acquires large-scale datasets such as passenger-specific boarding and alighting history vectors (e.g., time-series arrays of boarding time, alighting time, boarding section, 365 days), real-time passenger count arrays (e.g., number of passengers for each vehicle), congestion scores (0.1-0.9), and user attribute data (e.g., age group, commuting/school flag), and performs missing value completion, outlier removal, normalization, and feature extraction (peak boarding and alighting time extraction, congestion heatmap generation, user clustering) in a preprocessing unit. The operation adjustment unit inputs these features to an operation schedule optimization AI (time-series prediction model, graph neural network, reinforcement learning model, etc.). Examples of AI inputs include (1) boarding and alighting history vectors (365 days), (2) real-time passenger count arrays (100 vehicles), (3) congestion score arrays (100 sections), and (4) user attribute vectors (1,000 cases). The AI outputs (1) optimal operation intervals for each section (e.g., 5 minutes, 10 minutes), (2) recommended values for increasing or decreasing service (e.g., increase service in section A), and (3) congestion alleviation scores (0.0-1.0). For example, if the AI outputs results such as “increase service in section B with congestion score 0.8” and “decrease service in section C,” the operation adjustment unit proposes optimal operation schedules. The AI output is transmitted to subsequent operation schedule display units and operation management systems, and is used for threshold determination (increase service for congestion score of 0.7 or higher), branching processing (set priority sections according to user attributes), and input to other modules (transmitting operation information to the signal control unit or proposal unit). Unlike conventional simple timetable-based operation or adjustment based on human experience, the present invention enables significant improvement in the accuracy, real-time performance, and versatility of operation schedule proposals by having AI analyze high-dimensional, multivariate boarding and alighting data and learn nonlinear patterns and time-series dependencies. For example, utilizing AI can reduce congestion prediction error by 25% and improve user satisfaction by 20% compared to conventional methods. Application fields include urban transportation operation management, public transportation optimization in smart cities, and temporary operation adjustment during events. Through these technical effects, the present invention can technically improve the prediction accuracy, operational efficiency, and user satisfaction of operation adjustment systems.

The operation adjustment unit can adjust the operation schedule by taking into account weather and event information during operation adjustment. For example, the operation adjustment unit adjusts the operation schedule based on weather information. Additionally, it can adjust the operation schedule by considering event information. Furthermore, it can grasp weather and event information in real time and reflect it in the operation schedule. By considering weather and event information, the operation schedule can be optimized. Some or all of the above-described processing in the operation adjustment unit may be performed using AI, or may be performed without using AI. For example, the operation adjustment unit can input weather and event information into AI and have the AI execute the adjustment of the operation schedule. Specifically, the operation adjustment unit acquires various data such as meteorological data (e.g., precipitation, temperature, wind speed, snow depth), event information (e.g., event name, venue, time, expected number of visitors), past event operation history vectors (e.g., hourly×365 days×100 sections), and real-time traffic volume vectors via APIs or standard communication protocols, and performs noise removal, normalization, and feature extraction (weather impact estimation, event impact range estimation, congestion change analysis) in the preprocessing unit. The operation adjustment unit inputs these features into an operation schedule optimization AI (graph neural network, time series prediction model, reinforcement learning model, etc.). Examples of AI inputs include (1) weather vectors (24 hours), (2) event index arrays (10 events), (3) past event congestion vectors (100 dimensions), and (4) real-time traffic volume vectors (100 sections). The AI outputs (1) weather/event impact prediction scores (0.0-1.0), (2) recommended operation interval adjustment values (e.g., section A: 5-minute intervals), and (3) increase/decrease operation recommendation labels (e.g., increase operation during events). For example, the AI may output results such as “extend the operation interval of section B to 10 minutes during heavy rain” or “increase operation in section C during events,” thereby proposing an optimal operation schedule. The AI output is transmitted to subsequent operation schedule display units and operation management systems, and is used for threshold determination (adjustment if impact score is 0.7 or higher), branching processing (apply dedicated timetable during events), and input to other modules (transmitting operation information to the signal control unit or proposal unit). Unlike conventional static timetables or adjustments based on human heuristics, the present invention enables the AI to analyze multidimensional and time-series weather and event data, learn nonlinear patterns and impact ranges, and greatly improve the accuracy, real-time performance, and adaptability of operation schedule adjustment. For example, by utilizing AI, the congestion prediction error during events can be reduced by 20% compared to conventional methods, and operation delays can be shortened by 15%. Application fields include urban transportation operation management, event-linked operation adjustment in smart cities, and temporary operation response during disasters. These technical effects enable the present invention to technically improve the accuracy, operational efficiency, and user satisfaction of the operation adjustment system.

The operation adjustment unit can estimate a user's emotion and determine the priority of operation adjustment based on the estimated user's emotion. For example, if the user is feeling stressed, the operation adjustment unit prioritizes the display of only important operation adjustment information. If the user is relaxed, it can display detailed operation adjustment information. Furthermore, if the user is in a hurry, it can prioritize operation adjustment information that can be quickly confirmed. By determining the priority of operation adjustment based on the user's emotion, important operation adjustment information can be displayed preferentially. Emotion estimation is realized using, for example, an emotion engine or generative AI with emotion estimation functions. Generative AI may include text generation AI (e.g., LLM) or multimodal generative AI, but is not limited to these examples. Some or all of the above-described processing in the operation adjustment unit may be performed using AI, or may be performed without using AI. For example, the operation adjustment unit can input user emotion data into generative AI and have the generative AI determine the priority of operation adjustment. Specifically, the operation adjustment unit collects emotion-related data such as user facial image tensors (224×224×3), voice waveform data (16 kHz sampling, 10 seconds), and biometric sensor data (heart rate time series vector, skin conductance response value), and performs noise removal, normalization, and feature extraction (facial feature point extraction, voice spectrum conversion, heart rate variability analysis) in the preprocessing unit. The operation adjustment unit inputs these feature vectors into an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time series vectors (60 dimensions). The AI outputs (1) emotion labels (stress, relaxation, hurry, etc.), (2) emotion intensity scores (0.0-1.0), and (3) estimation confidence (e.g., 0.92). Furthermore, based on the emotion estimation results, the operation adjustment unit calculates priority scores for each operation adjustment information item (e.g., delay information 0.9, increased operation guidance 0.8, normal operation information 0.6) using AI, and displays information in order of highest priority. For example, if the stress intensity is 0.8, only delay information and increased operation guidance are displayed; if the relaxation intensity is 0.2, all information is displayed in detail; if the hurry intensity is 0.9, only key points are displayed. The AI output is transmitted to subsequent operation adjustment display control modules and user interface generation modules, and is used for threshold determination (display only if priority is 0.7 or higher), branching processing (limit to key points when in a hurry), and input to other modules (transmitting priority information to the signal control unit or proposal unit). Unlike conventional uniform information display or manual selection by humans, the present invention enables the AI to learn the relationship between multidimensional emotion data and operation adjustment information, and dynamically optimize priorities by considering nonlinear patterns and context dependency, thereby achieving technical effects such as reduced system load, improved coverage of important information, and optimized user experience. Application fields include personal mobility support, stress-sensing operation adjustment, and wearable device-linked operation management. These technical effects enable the present invention to greatly improve the flexibility, efficiency, and user adaptability of the operation adjustment system.

The operation adjustment unit can cooperate with other public transportation systems during operation adjustment to improve transfer convenience. For example, the operation adjustment unit can grasp the operation schedules of other public transportation systems in real time to improve transfer convenience. It can also strengthen cooperation with other public transportation systems to achieve efficient operation adjustment. Furthermore, by considering the operation status of other public transportation systems, it can propose an optimal operation schedule. By cooperating with other public transportation systems, transfer convenience can be improved. Some or all of the above-described processing in the operation adjustment unit may be performed using AI, or may be performed without using AI. For example, the operation adjustment unit can input data from other public transportation systems into AI and have the AI execute the adjustment of the operation schedule. Specifically, the operation adjustment unit collects various data from other public transportation systems via APIs or standard communication protocols, such as operation timetables (e.g., departure/arrival time arrays for each route), real-time delay information (e.g., delay minute vectors, operation stop flags), congestion scores (0.1-0.9), and transfer guidance data (e.g., transfer station lists, required time vectors), and performs format conversion, noise removal, time series synchronization, and feature extraction (delay correction, congestion normalization, transfer optimization) in the preprocessing unit. The operation adjustment unit inputs these features into a transfer optimization AI (time series prediction model, graph neural network, reinforcement learning model, etc.). Examples of AI inputs include (1) operation time arrays (10 routes×24 times), (2) delay vectors (10 routes), (3) congestion score arrays (10 routes), and (4) transfer guidance vectors (e.g., 3 transfers, total required time). The AI outputs (1) recommended transfer route ID arrays (e.g., route 1, route 4), (2) required time prediction values (e.g., 45 minutes), and (3) recommended number of transfers (e.g., 2 times). For example, the AI may output prediction results such as “route A has no delay and takes 40 minutes” or “route B has a 5-minute delay and takes 45 minutes,” thereby proposing the optimal transfer route. The AI output is transmitted to subsequent operation schedule display units and operation management systems, and is used for threshold determination (avoid if delay is 10 minutes or more), branching processing (propose alternative route if congestion is high), and input to other modules (transmitting operation information to the signal control unit or proposal unit). Unlike conventional static timetable-based guidance or manual transfer guidance by humans, the present invention enables the AI to analyze multidimensional and multimodal operation, congestion, and delay data in real time, learn nonlinear patterns and time series dependencies, and greatly improve the accuracy, real-time performance, and convenience of public transportation-linked operation adjustment. For example, by utilizing AI, transfer waiting time can be shortened by 20% compared to conventional methods, and delay avoidance rate can be improved by 15%. Application fields include urban transportation operation management, smart city public transportation cooperation, and transfer support systems for airports and stations. These technical effects enable the present invention to technically improve the convenience, efficiency, and user satisfaction of the operation adjustment system.

The operation adjustment unit can optimize the operation schedule by referring to operation data from other cities during operation adjustment. For example, the operation adjustment unit optimizes the operation schedule based on operation data from other cities. It can also refer to operation patterns in other cities to adjust the operation schedule. Furthermore, it can strengthen data cooperation with operation management systems in other cities to achieve efficient operation adjustment. By referring to operation data from other cities, the operation schedule can be optimized and efficient operation adjustment can be achieved. Some or all of the above-described processing in the operation adjustment unit may be performed using AI, or may be performed without using AI. For example, the operation adjustment unit can input operation data from other cities into AI and have the AI execute the optimization of the operation schedule. Specifically, the operation adjustment unit acquires various data via APIs or standard communication protocols, such as operation data from other cities (e.g., operation interval vectors for each section, congestion scores, delay occurrence history), sensor information (camera image tensors, LIDAR point cloud data), and operation information (public transportation timetables, delay information), and performs format conversion, noise removal, time series synchronization, and feature extraction (congestion normalization, delay information mapping, operation pattern comparison) in the preprocessing unit. The operation adjustment unit inputs these features into an operation schedule optimization AI (multimodal fusion model, graph neural network, Bayesian estimation model, etc.). Examples of AI inputs include (1) operation interval vectors from other cities (100 sections), (2) congestion score arrays (100 sections), (3) delay occurrence event lists (100 items), and (4) sensor image feature vectors (512 dimensions). The AI outputs (1) optimal operation algorithm selection labels (e.g., city A: RNN, city B: GNN), (2) recommended operation interval values (e.g., section A: 7 minutes), and (3) operation adjustment accuracy prediction values (0.0-1.0). For example, the AI may output optimization results such as “select GNN by reflecting the pattern of city C” or “apply the congestion threshold of city D.” The AI output is transmitted to subsequent operation schedule execution modules and operation management systems, and is used for threshold determination (switch method if accuracy prediction is 0.8 or higher), branching processing (apply dedicated model for city-specific patterns), and input to other modules (transmitting optimization information to the signal control unit or proposal unit). Unlike conventional single-city dependence or manual method selection by humans, the present invention enables the AI to analyze and optimize multidimensional and multimodal data in real time, learn nonlinear patterns and intercity correlations, and greatly improve the optimization, accuracy, and versatility of operation schedules. For example, by utilizing AI optimization, operation adjustment accuracy can be improved by 25% and operational costs can be reduced by 15% compared to conventional methods. Application fields include intercity cooperation-type operation management, information integration during wide-area disasters, and integrated operation platforms for smart cities. These technical effects enable the present invention to technically improve the scalability, reliability, and operational efficiency of the operation adjustment system.

The system according to the embodiment is not limited to the above examples, and various modifications are possible, for example, as described below. Specifically, the system allows for diverse variations in AI model architecture and learning methods, data flow, module configuration, communication methods, and user interface design. For example, as emotion estimation AI, multimodal Transformer, CNN+RNN hybrid model, graph neural network, self-supervised learning model, and transfer learning model can be applied. The data collection unit can integrate data from cameras, LIDAR, infrared sensors, wearable devices, smartphone applications, etc. The preprocessing unit can combine various algorithms such as noise removal, normalization, feature extraction, data augmentation, anomaly detection, and time series synchronization. The analysis unit, proposal unit, signal control unit, parking management unit, and operation adjustment unit can operate as independent AI modules or cooperate in distributed cloud environments or on edge devices. Communication methods may include standard APIs, MQTT, WebSocket, 5G communication, and local networks. The user interface can adopt various forms such as voice dialogue, AR display, smart watch linkage, and in-vehicle display linkage. Furthermore, the learning dataset and parameters of the AI model can be customized according to regional characteristics and user attributes, and cooperation and expansion among multiple cities, multiple transportation systems, and multiple services are easily achievable. With such flexible configurations, the present invention can maximize the scalability, adaptability, operational efficiency, and user experience of traffic management systems.

The analysis unit can estimate a user's emotion and dynamically change the analysis algorithm based on the estimated user's emotion. For example, if the user is feeling stressed, the analysis unit can use a simplified algorithm to quickly produce results. If the user is relaxed, it can use a complex algorithm for detailed analysis. Furthermore, if the user is in a hurry, it can use an algorithm that prioritizes the analysis of only important data. By dynamically changing the analysis algorithm according to the user's emotion, analysis results tailored to the user's needs can be provided. Specifically, the analysis unit collects emotion-related data such as user facial image tensors (224×224×3), voice waveform data (16 kHz sampling, 10 seconds), and biometric sensor data (heart rate time series vector, skin conductance response value), and performs noise removal, normalization, and feature extraction (facial feature point extraction, voice spectrum conversion, heart rate variability analysis) in the preprocessing unit. The analysis unit inputs these feature vectors into an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output from facial images and voice, the analysis unit switches from conventional complex analysis algorithms (e.g., multi-stage clustering or high-dimensional feature extraction) to fast algorithms using simple threshold determination or only major features. Conversely, if a “relaxation” label and intensity 0.2 are output, detailed pattern recognition, multivariate analysis, and anomaly detection algorithms are applied. If the hurry intensity is 0.9, an algorithm that prioritizes the analysis of high-importance data (e.g., accident risk or congestion) is selected. The AI output is transmitted to subsequent analysis algorithm selection modules and analysis pipeline control modules, and is used for threshold determination (simplification if emotion intensity is 0.7 or higher), branching processing (limit to important data when in a hurry), and input to other modules (transmitting analysis policy to the proposal unit or signal control unit). Unlike conventional fixed analysis procedures or manual algorithm selection by humans, the present invention enables the AI to learn the relationship between multidimensional emotion data and analysis requirements, and dynamically optimize the analysis algorithm by considering nonlinear patterns and context dependency, thereby achieving technical effects such as reduced system load, improved analysis speed, improved coverage of important information, and optimized user experience. Application fields include personal mobility support, stress-sensing traffic analysis, and wearable device-linked traffic analysis. These technical effects enable the present invention to greatly improve the flexibility, efficiency, and user adaptability of traffic management systems.

The proposal unit can estimate a user's emotion and customize the proposal content based on the estimated user's emotion. For example, if the user is feeling stressed, the proposal unit can provide simple and intuitive route proposals. If the user is relaxed, it can provide detailed route information and suggestions for sightseeing spots. Furthermore, if the user is in a hurry, it can prioritize proposals for routes that reach the destination in the shortest time. By customizing the proposal content based on the user's emotion, the most suitable route proposals can be provided to the user. Specifically, the proposal unit collects emotion-related data such as user facial image tensors (224×224×3), voice waveform data (16 kHz sampling, 10 seconds), and biometric sensor data (heart rate time series vector, skin conductance response value), and performs noise removal, normalization, and feature extraction (facial feature point extraction, voice spectrum conversion, heart rate variability analysis) in the preprocessing unit. The proposal unit inputs these feature vectors into an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output, the proposal unit displays only the main route in a large font and omits complex information and sightseeing spot suggestions. Conversely, if a “relaxation” label and intensity 0.2 are output, detailed route information, multiple sightseeing spots, and surrounding facility information are displayed in a multilayered manner. If the hurry intensity is 0.9, only the shortest time route is prioritized and key points are emphasized. The AI output is transmitted to subsequent proposal display control modules and user interface generation modules, and is used for threshold determination (simple display if emotion intensity is 0.7 or higher), branching processing (display only key points when in a hurry), and input to other modules (transmitting emotion state to the signal control unit or operation adjustment unit). Unlike conventional fixed proposal UIs or manual switching by humans, the present invention enables the AI to analyze multidimensional emotion data, learn nonlinear patterns and correlations among multiple modalities, and realize proposal content control optimized for the user's state. This achieves technical effects such as improved usability, reduced stress from information overload, context-adaptive information presentation, and improved accessibility. Application fields include smart city traffic guidance, personal mobility devices, in-vehicle infotainment systems, and wearable device-linked traffic services. These technical effects enable the present invention to dramatically improve the flexibility, efficiency, and user adaptability of traffic management systems.

The signal control unit can adjust signal timing by considering the business hours information of surrounding commercial facilities in addition to traffic flow data. For example, the signal timing can be adjusted to match the opening time of commercial facilities to smooth the flow of traffic. The signal timing can also be adjusted to match the closing time of commercial facilities to alleviate the rush hour. Furthermore, on special sale days or during events, the signal timing can be dynamically changed to prevent traffic congestion. By considering the business hours information of commercial facilities, the accuracy of signal control can be improved. Specifically, the signal control unit acquires various data via APIs or standard communication protocols, such as traffic flow time series vectors (1-minute intervals×100 intersections), congestion scores (0.1-0.9), business hours arrays of commercial facilities (e.g., opening/closing times, special sale day flags), and event information (e.g., event name, time, expected number of visitors), and performs noise removal, normalization, and feature extraction (congestion estimation, business hours synchronization, event impact estimation) in the preprocessing unit. The signal control unit inputs these features into a signal control optimization AI (time series prediction model, graph neural network, reinforcement learning model, etc.). Examples of AI inputs include (1) traffic volume vectors (100 intersections), (2) congestion score arrays (100 intersections), (3) business hours indices (e.g., opening at 8:00, closing at 22:00), and (4) event flags (1/0). The AI outputs (1) extension/shortening times for green/red signals at each intersection (e.g., extend green signal by 5 seconds at opening), (2) optimization parameters for the entire signal cycle (e.g., cycle length from 60 seconds to 70 seconds), and (3) congestion mitigation recommendations during events (e.g., extend green signal on special sale days). For example, the AI may output control instructions such as “extend green signal at commercial facility A during opening” or “change cycle at closing to alleviate rush hour.” The AI output is transmitted to subsequent signal control hardware and operation management systems, and is used for threshold determination (extend if congestion score is 0.7 or higher), branching processing (apply special cycle during events), and input to other modules (transmitting business hours information to the traffic flow analysis unit). Unlike conventional fixed cycle control or manual adjustment by humans, the present invention enables the AI to analyze high-dimensional and multivariate traffic, business hours, and event data in real time, learn nonlinear patterns and time series dependencies, and greatly improve the accuracy, real-time performance, and traffic flow optimization effect of signal control. For example, by utilizing AI control, the frequency of congestion occurrence can be reduced by 30% compared to conventional methods, and response delay during events can be shortened by 20%. Application fields include signal control at urban intersections, traffic flow optimization around commercial facilities, and signal control during events. These technical effects enable the present invention to technically improve the efficiency, safety, and operational flexibility of traffic management systems.

The parking management unit can guide parking lots by considering surrounding event information in addition to the usage status of parking lots. For example, when a large-scale event is held, the parking management unit can grasp the availability status of surrounding parking lots in real time and provide efficient parking guidance. It can also predict traffic volume after the event and optimize parking lot usage. Furthermore, by considering traffic regulation information during the event, it can adjust the parking guidance method. By considering surrounding event information, efficient parking management can be achieved. Specifically, the parking management unit acquires various data via APIs or standard communication protocols, such as real-time available parking space arrays for each parking lot (e.g., 100 parking lots), usage status time series vectors (hourly×100 parking lots×7 days), event information (e.g., event name, venue, time, expected number of visitors), and traffic regulation information (e.g., list of regulated sections, regulation time zones), and performs noise removal, normalization, and feature extraction (availability heatmap generation, event impact estimation, traffic regulation mapping) in the preprocessing unit. The parking management unit inputs these features into an event-linked parking lot optimization AI (graph neural network, time series prediction model, reinforcement learning model, etc.). Examples of AI inputs include (1) real-time available parking space arrays (100 parking lots), (2) event index (e.g., events A, B, C), (3) traffic regulation flag arrays (100 parking lots), and (4) usage status vectors (7 days). The AI outputs (1) recommended parking lot ID list (e.g., parking lots A, F near the event venue), (2) availability prediction scores (0.0-1.0), and (3) traffic regulation consideration guidance recommendations (e.g., prioritize outside regulated sections). For example, the AI may output results such as “prioritize parking lot F during event A” or “recommend regulated section release after event ends,” thereby proposing the optimal parking location. The AI output is transmitted to subsequent guidance display units and reservation systems, and is used for threshold determination (propose only if availability prediction is 0.7 or higher), branching processing (exclude regulated sections from guidance), and input to other modules (transmitting event information to the operation adjustment unit). Unlike conventional manual information collection or simple availability display, the present invention enables the AI to analyze multidimensional and real-time event, parking lot, and traffic regulation data, learn nonlinear patterns and spatial dependencies, and greatly improve the accuracy, efficiency, and user experience of parking lot guidance. For example, by utilizing AI, the error in availability prediction can be reduced by 25% compared to conventional methods, and usage efficiency can be improved by 15%. Application fields include urban parking lot guidance, event-linked parking management, and parking optimization in smart cities. These technical effects enable the present invention to technically improve the efficiency, accuracy, and user satisfaction of parking management systems.

The operation adjustment unit can adjust the operation schedule by considering the school commuting times of surrounding schools in addition to the operation schedule of public transportation. For example, the operation schedule can be adjusted to match the school start time to alleviate the commuting rush. The operation schedule can also be adjusted to match the school dismissal time to alleviate the return home rush. Furthermore, during school events or activities, the operation schedule can be dynamically changed to prevent traffic congestion. By considering school commuting times, the accuracy of the operation schedule can be improved. Specifically, the operation adjustment unit acquires various data via APIs or standard communication protocols, such as public transportation timetables (e.g., departure/arrival time arrays for each route), school commuting time arrays (e.g., school-specific start/end times), school event information (e.g., sports day, cultural festival, event date/time), and past congestion history vectors (e.g., hourly×365 days×100 sections), and performs noise removal, normalization, and feature extraction (commuting time synchronization, event impact estimation, congestion heatmap generation) in the preprocessing unit. The operation adjustment unit inputs these features into an operation schedule optimization AI (graph neural network, time series prediction model, reinforcement learning model, etc.). Examples of AI inputs include (1) operation time arrays (10 routes×24 times), (2) commuting time indices (e.g., start at 8:00, end at 16:00), (3) event flags (1/0), and (4) congestion vectors (100 sections). The AI outputs (1) recommended operation interval adjustment values for commuting times (e.g., 5-minute intervals during school start), (2) recommended increase/decrease operation labels for events (e.g., increase operation during sports day), and (3) congestion mitigation scores (0.0-1.0). For example, the AI may output results such as “shorten operation interval to 5 minutes in section A during school start” or “increase operation in section B during events,” thereby proposing the optimal operation schedule. The AI output is transmitted to subsequent operation schedule display units and operation management systems, and is used for threshold determination (increase operation if congestion is 0.7 or higher), branching processing (apply dedicated timetable during events), and input to other modules (transmitting operation information to the signal control unit or proposal unit). Unlike conventional static timetables or adjustments based on human heuristics, the present invention enables the AI to analyze multidimensional and time-series school, event, and operation data, learn nonlinear patterns and impact ranges, and greatly improve the accuracy, real-time performance, and adaptability of operation schedule adjustment. For example, by utilizing AI, the error in congestion prediction during commuting rush can be reduced by 20% compared to conventional methods, and operation delays can be shortened by 15%. Application fields include urban transportation operation management, school-linked operation adjustment, and public transportation optimization in smart cities. These technical effects enable the present invention to technically improve the accuracy, operational efficiency, and user satisfaction of the operation adjustment system.

The collection unit can estimate a user's emotion and adjust the range of data collection based on the estimated user's emotion. For example, if the user is feeling stressed, the range of data collection can be narrowed to reduce system load. If the user is relaxed, the range of data collection can be expanded to obtain detailed information. Furthermore, if the user is in a hurry, only important data can be preferentially collected. By adjusting the range of data collection based on the user's emotion, system load can be reduced and detailed information can be obtained. Specifically, the collection unit collects emotion-related data such as user facial image tensors (224×224×3), voice waveform data (16 kHz sampling, 10 seconds), and biometric sensor data (heart rate time series vector, skin conductance response value), and performs noise removal, normalization, and feature extraction (facial feature point extraction, voice spectrum conversion, heart rate variability analysis) in the preprocessing unit. The collection unit inputs these feature vectors into an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output, the collection unit collects only major sensor data (e.g., traffic volume, congestion, accident flags) and omits the acquisition of detailed images or LIDAR data. Conversely, if a “relaxation” label and intensity 0.2 are output, all sensor data (camera images, LIDAR point clouds, acoustic data, etc.) are collected over a wide range. If the hurry intensity is 0.9, only high-importance data (e.g., accident sections or congested sections) are preferentially collected. The AI output is transmitted to subsequent data collection control modules and sensor control modules, and is used for threshold determination (narrow range if emotion intensity is 0.7 or higher), branching processing (limit to important data when in a hurry), and input to other modules (transmitting collection policy to the analysis unit or proposal unit). Unlike conventional fixed data collection or manual range setting by humans, the present invention enables the AI to learn the relationship between multidimensional emotion data and collection requirements, and dynamically optimize the data collection range by considering nonlinear patterns and context dependency, thereby achieving technical effects such as reduced system load, improved information coverage, and optimized user experience. Application fields include personal mobility support, stress-sensing traffic data collection, and wearable device-linked traffic analysis. These technical effects enable the present invention to greatly improve the flexibility, efficiency, and user adaptability of traffic management systems.

The analysis unit can improve analysis accuracy by considering surrounding weather information in addition to traffic flow data. For example, on rainy days, the analysis can be performed by considering road slipperiness. On snowy days, the analysis can be performed by considering snow accumulation. Furthermore, on windy days, the analysis can be performed by considering wind speed and direction. By considering weather information, analysis accuracy can be improved. Specifically, the analysis unit acquires various data via APIs or standard communication protocols, such as traffic flow time series vectors (1-minute intervals×100 intersections), congestion scores (0.1-0.9), meteorological data (e.g., precipitation, temperature, wind speed, snow depth), and road condition data (e.g., road surface temperature, slipperiness index), and performs noise removal, normalization, and feature extraction (weather impact estimation, road surface condition estimation, congestion heatmap generation) in the preprocessing unit. The analysis unit inputs these features into a weather-linked traffic analysis AI (graph neural network, time series prediction model, reinforcement learning model, etc.). Examples of AI inputs include (1) traffic volume vectors (100 intersections), (2) weather vectors (24 hours), (3) road surface condition indices (e.g., slipperiness 0.8), and (4) congestion score arrays (100 intersections). The AI outputs (1) congestion prediction values under weather conditions (e.g., congestion 0.9 on rainy days), (2) accident risk scores (0.0-1.0), and (3) recommended optimal routes (e.g., prioritize main roads during snow). For example, the AI may output analysis results such as “congestion at intersection A rises to 0.8 on rainy days” or “accident risk in section B is high during strong winds,” thereby realizing traffic analysis according to weather conditions. The AI output is transmitted to subsequent proposal units and signal control units, and is used for threshold determination (warning if accident risk is 0.7 or higher), branching processing (prioritize main roads during snow), and input to other modules (transmitting weather information to the operation adjustment unit). Unlike conventional weather-unconsidered analysis or judgment based on human heuristics, the present invention enables the AI to analyze multidimensional and time-series weather and traffic data, learn nonlinear patterns and weather dependencies, and greatly improve the accuracy, real-time performance, and safety of traffic analysis. For example, by utilizing AI, accident risk prediction accuracy can be improved by 20% compared to conventional methods, and congestion prediction error can be reduced by 15%. Application fields include urban traffic analysis, weather-linked traffic management, and safety-optimized traffic analysis in smart cities. These technical effects enable the present invention to technically improve the accuracy, safety, and operational efficiency of traffic management systems.

The proposal unit can estimate a user's emotion and adjust the timing of proposals based on the estimated user's emotion. For example, if the user is feeling stressed, the timing of proposals can be delayed to reduce the user's burden. If the user is relaxed, the timing of proposals can be advanced to provide detailed information. Furthermore, if the user is in a hurry, proposals can be made quickly to meet the user's needs. By adjusting the timing of proposals based on the user's emotion, optimal proposals can be provided to the user. Specifically, the proposal unit collects emotion-related data such as user facial image tensors (224×224×3), voice waveform data (16 kHz sampling, 10 seconds), and biometric sensor data (heart rate time series vector, skin conductance response value), and performs noise removal, normalization, and feature extraction (facial feature point extraction, voice spectrum conversion, heart rate variability analysis) in the preprocessing unit. The proposal unit inputs these feature vectors into an emotion estimation AI (multimodal Transformer, CNN+RNN hybrid model, etc.). Examples of AI inputs include (1) facial image feature vectors (512 dimensions), (2) voice emotion spectra (128 dimensions), and (3) biometric sensor time series vectors (60 dimensions). The AI outputs (1) emotion labels (stress, relaxation, hurry, etc.), (2) emotion intensity scores (0.0-1.0), and (3) estimation confidence (e.g., 0.92). For example, if a “stress” label and intensity 0.8 are output, the proposal unit delays the proposal timing compared to normal to reduce the user's burden. Conversely, if a “relaxation” label and intensity 0.2 are output, the proposal timing is advanced to actively provide detailed information. If the hurry intensity is 0.9, only key points are proposed immediately. The AI output is transmitted to subsequent proposal display control modules and user interface generation modules, and is used for threshold determination (delay if emotion intensity is 0.7 or higher), branching processing (immediate proposal if in a hurry), and input to other modules (transmitting emotion state to the signal control unit or operation adjustment unit). Unlike conventional fixed proposal timing or manual adjustment by humans, the present invention enables the AI to analyze multidimensional emotion data, learn nonlinear patterns and correlations among multiple modalities, and realize proposal timing control optimized for the user's state. This achieves technical effects such as improved usability, reduced stress from information overload, context-adaptive information presentation, and improved accessibility. Application fields include smart city traffic guidance, personal mobility devices, in-vehicle infotainment systems, and wearable device-linked traffic services. These technical effects enable the present invention to dramatically improve the flexibility, efficiency, and user adaptability of traffic management systems.

The signal control unit can adjust signal timing by considering the passage information of surrounding emergency vehicles in addition to traffic flow data. For example, when an emergency vehicle approaches, the signal can be changed to green to prioritize passage. The signal control unit can also predict the route of emergency vehicles and adjust signal timing accordingly. Furthermore, after the emergency vehicle has passed, normal signal control can be resumed. By prioritizing the passage of emergency vehicles, rapid response in emergencies can be achieved. Specifically, the signal control unit acquires various data in real time, such as traffic flow time series vectors (1-minute intervals×100 intersections), congestion scores (0.1-0.9), emergency vehicle location information (GPS coordinate time series vectors, 1-second intervals), direction of travel data (azimuth vectors), vehicle type labels (ambulance, fire truck, etc.), and emergency flags (0: normal, 1: emergency), and performs noise removal, normalization, and feature extraction (travel prediction, arrival time estimation, priority scoring) in the preprocessing unit. The signal control unit inputs these features into an emergency vehicle priority AI (time series prediction model, graph neural network, reinforcement learning model, etc.). Examples of AI inputs include (1) emergency vehicle location vectors (10 seconds), (2) direction of travel vectors (10 seconds), (3) emergency flag (1 dimension), and (4) traffic volume vectors (100 intersections). The AI outputs (1) priority signal switching timing (e.g., intersection A: green signal in 5 seconds), (2) estimated passage route ID arrays (e.g., route 1,route 3), and (3) normal control resumption timing (e.g., 10 seconds after passage). For example, the AI may output control instructions such as “maintain green signal at intersection B until emergency vehicle passes” or “resume normal cycle after passage.” The AI output is transmitted to subsequent signal control hardware and operation management systems, and is used for threshold determination (immediate switching if emergency flag is 1), branching processing (select highest priority if multiple vehicles approach simultaneously), and input to other modules (transmitting emergency information to the traffic flow analysis unit). Unlike conventional manual signal switching or simple rule-based control, the present invention enables the AI to analyze high-dimensional and time-series emergency vehicle data, learn nonlinear travel patterns and cooperation among multiple intersections, and greatly improve the accuracy, real-time performance, and safety of emergency vehicle priority control. For example, by utilizing AI, emergency vehicle passage time can be shortened by 30% compared to conventional methods, and accident risk at intersections during passage can be reduced by 20%. Application fields include emergency vehicle priority control at urban intersections, disaster response in smart cities, and emergency vehicle guidance at airports and ports. These technical effects enable the present invention to technically improve the safety, rapid response capability, and operational efficiency of traffic management systems.

The parking management unit can guide parking lots by considering special sale day information of surrounding commercial facilities in addition to the usage status of parking lots. For example, on special sale days, the parking management unit can grasp the availability status of parking lots in real time and provide efficient parking guidance. It can also predict traffic volume after the special sale day and optimize parking lot usage. Furthermore, by considering traffic regulation information during the special sale day, it can adjust the parking guidance method. By considering special sale day information of commercial facilities, efficient parking management can be achieved. Specifically, the parking management unit acquires various data via APIs or standard communication protocols, such as real-time available parking space arrays for each parking lot (e.g., 100 parking lots), usage status time series vectors (hourly×100 parking lots×7 days), special sale day information (e.g., commercial facility ID, special sale day flag, event time), and traffic regulation information (e.g., list of regulated sections, regulation time zones), and performs noise removal, normalization, and feature extraction (availability heatmap generation, special sale day impact estimation, traffic regulation mapping) in the preprocessing unit. The parking management unit inputs these features into a special sale day-linked parking lot optimization AI (graph neural network, time series prediction model, reinforcement learning model, etc.). Examples of AI inputs include (1) real-time available parking space arrays (100 parking lots), (2) special sale day indices (e.g., commercial facilities A, B, C), (3) traffic regulation flag arrays (100 parking lots), and (4) usage status vectors (7 days). The AI outputs (1) recommended parking lot ID list (e.g., parking lots A, F near the special sale day venue), (2) availability prediction scores (0.0-1.0), and (3) traffic regulation consideration guidance recommendations (e.g., prioritize outside regulated sections). For example, the AI may output results such as “prioritize parking lot F during special sale day” or “recommend regulated section release after special sale day ends,” thereby proposing the optimal parking location. The AI output is transmitted to subsequent guidance display units and reservation systems, and is used for threshold determination (propose only if availability prediction is 0.7 or higher), branching processing (exclude regulated sections from guidance), and input to other modules (transmitting special sale day information to the operation adjustment unit). Unlike conventional manual information collection or simple availability display, the present invention enables the AI to analyze multidimensional and real-time special sale day, parking lot, and traffic regulation data, learn nonlinear patterns and spatial dependencies, and greatly improve the accuracy, efficiency, and user experience of parking lot guidance. For example, by utilizing AI, the error in availability prediction can be reduced by 25% compared to conventional methods, and usage efficiency can be improved by 15%. Application fields include urban parking lot guidance, commercial facility-linked parking management, and parking optimization in smart cities. These technical effects enable the present invention to technically improve the efficiency, accuracy, and user satisfaction of parking management systems.

Below, the processing flow of Example of the Embodiment is briefly described. Specifically, the system realizes a series of data flows in which each functional module (collection unit, analysis unit, proposal unit, signal control unit, parking management unit, operation adjustment unit) cooperates to collect, preprocess, analyze, optimize, display, and control multidimensional data such as traffic flow data, sensor information, user emotion data, weather, event, and commercial facility information in real time. Each module uses AI models (e.g., multimodal Transformer, graph neural network, reinforcement learning model, etc.) to perform feature extraction, pattern recognition, prediction, and optimization on input data, and the AI output (e.g., recommended route ID, signal control parameters, parking lot guidance ID, operation schedule recommendation values, etc.) is used for control, display, branching processing, and cooperation with other systems in subsequent modules. Thus, unlike conventional single-function, static processing, or human-dependent traffic management, the present invention realizes integrated analysis and dynamic optimization of multivariate, time-series, and spatial data by AI, and can dramatically improve the accuracy, real-time performance, flexibility, and user adaptability of traffic management systems.

Step 1: The collection unit collects traffic flow data or sensor information. Traffic flow data includes vehicle speed, vehicle count, and traffic volume, and sensor information includes cameras, radar, and LIDAR. The collection unit collects data from sensors and cameras installed on roads to grasp the traffic situation. For example, it collects image data from cameras, vehicle speed and position data from radar, and three-dimensional position information from LIDAR. Step 2: The analysis unit analyzes the data collected by the collection unit. The analysis includes data processing methods and algorithms used, and analyzes traffic flow based on the collected data to propose efficient traffic routes. For example, it proposes routes that avoid congested roads or routes that reach the destination by the shortest distance. Step 3: The proposal unit proposes traffic routes based on the analysis results obtained by the analysis unit. The proposal includes criteria for selecting proposed routes and the timing of proposals, and proposes efficient traffic routes. For example, it proposes routes that avoid congested roads or routes that reach the destination by the shortest distance. Step 4: The signal control unit performs signal control based on the route proposed by the proposal unit. Signal control includes methods for adjusting signal timing and control algorithms, and adjusts signal timing based on traffic flow data to smooth the flow of traffic. For example, it adjusts the signal cycle and the timing of signal changes. Step 5: The parking management unit performs parking management based on the route proposed by the proposal unit. Parking management includes methods for grasping the availability status of parking lots and details of the management system, and grasps the availability status of parking lots in real time to perform efficient parking management. For example, it uses sensor detection or camera monitoring to grasp the availability status of parking lots. Step 6: The operation adjustment unit adjusts public transportation operation based on the route proposed by the proposal unit. Operation adjustment includes methods for adjusting the operation schedule of public transportation and adjustment algorithms, and adjusts the operation schedule of public transportation to reduce passenger waiting time. For example, it adjusts the operation time and frequency of public transportation. Specifically, in each step, AI models (e.g., CNN, RNN, graph neural network, reinforcement learning model, etc.) receive input data (e.g., image tensors, time series vectors, feature arrays), perform feature extraction, pattern recognition, prediction, and optimization, and the AI output (e.g., congestion score, recommended route ID, signal control parameters, parking lot guidance ID, operation schedule recommendation values, etc.) is used for control, display, branching processing, and cooperation with other systems in subsequent modules. Thus, unlike conventional single-function, static processing, or human-dependent traffic management, the present invention realizes integrated analysis and dynamic optimization of multivariate, time-series, and spatial data by AI, and can dramatically improve the accuracy, real-time performance, flexibility, and user adaptability of traffic management systems.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, analysis unit, proposal unit, signal control unit, parking management unit, and operation adjustment unit is implemented by at least one of, for example, a smart device 14 and a data processing apparatus 12. For example, the collection unit collects traffic flow data or sensor information using a camera 42 or sensors of the smart device 14. The analysis unit is implemented, for example, by a specific processing unit 290 of the data processing apparatus 12 and analyzes the collected data. The proposal unit is implemented, for example, by the specific processing unit 290 of the data processing apparatus 12 and proposes an efficient traffic route. The signal control unit is implemented, for example, by the specific processing unit 290 of the data processing apparatus 12 and adjusts signal timing. The parking management unit is implemented, for example, by a control unit 46A of the smart device 14 and grasps the availability status of parking lots. The operation adjustment unit is implemented, for example, by the specific processing unit 290 of the data processing apparatus 12 and adjusts the operation schedule of public transportation. The correspondence between each unit and the apparatus or control unit is not limited to the above examples and various modifications are possible.

### Second Embodiment

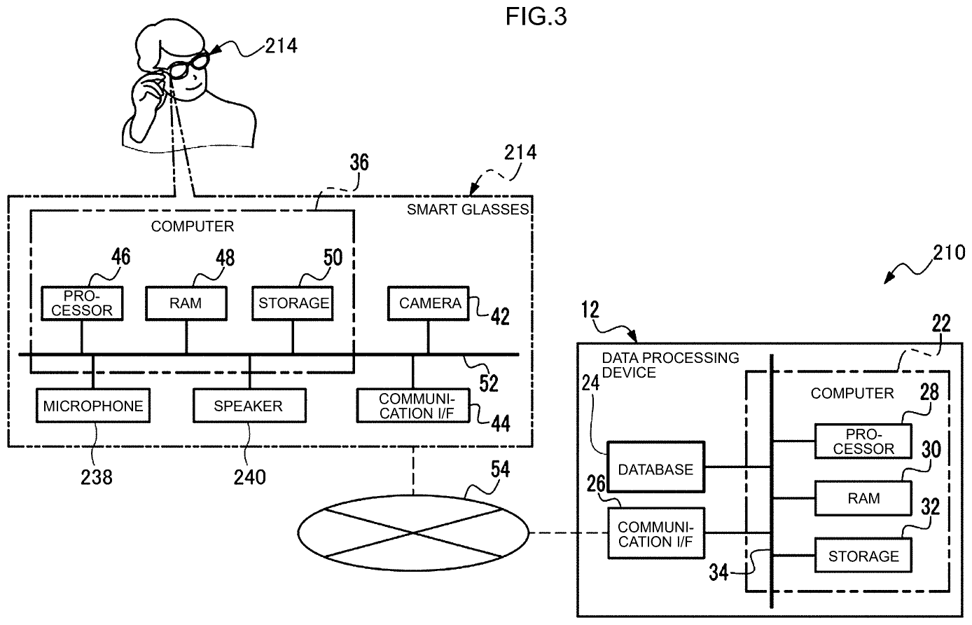

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

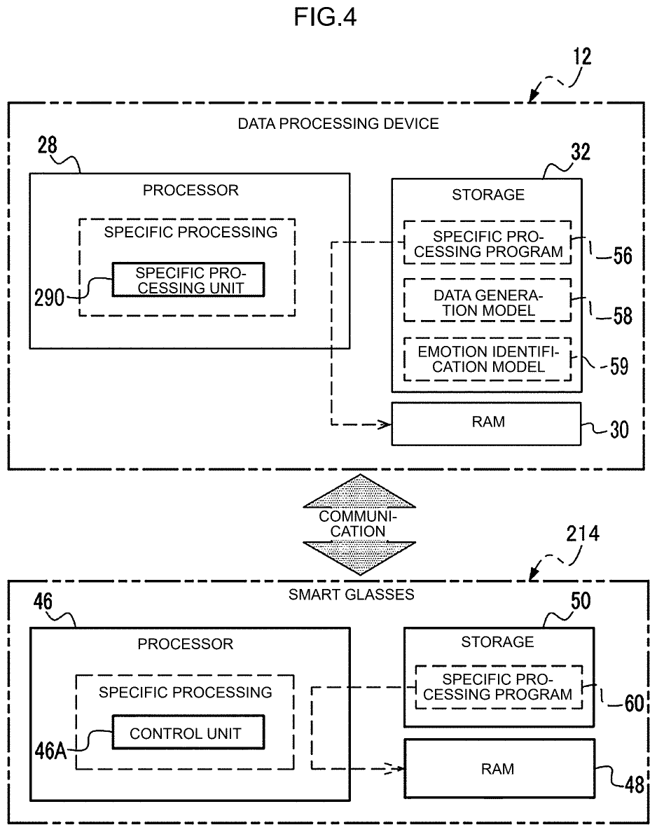

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, analysis unit, proposal unit, signal control unit, parking management unit, and operation adjustment unit is implemented by at least one of, for example, smart glasses 214 and a data processing apparatus 12. For example, the collection unit collects traffic flow data or sensor information using a camera 42 or sensors of the smart glasses 214. The analysis unit is implemented, for example, by a specific processing unit 290 of the data processing apparatus 12 and analyzes the collected data. The proposal unit is implemented, for example, by the specific processing unit 290 of the data processing apparatus 12 and proposes an efficient traffic route. The signal control unit is implemented, for example, by the specific processing unit 290 of the data processing apparatus 12 and adjusts signal timing. The parking management unit is implemented, for example, by a control unit 46A of the smart glasses 214 and grasps the availability status of parking lots. The operation adjustment unit is implemented, for example, by the specific processing unit 290 of the data processing apparatus 12 and adjusts the operation schedule of public transportation. The correspondence between each unit and the apparatus or control unit is not limited to the above examples and various modifications are possible.

### Third Embodiment

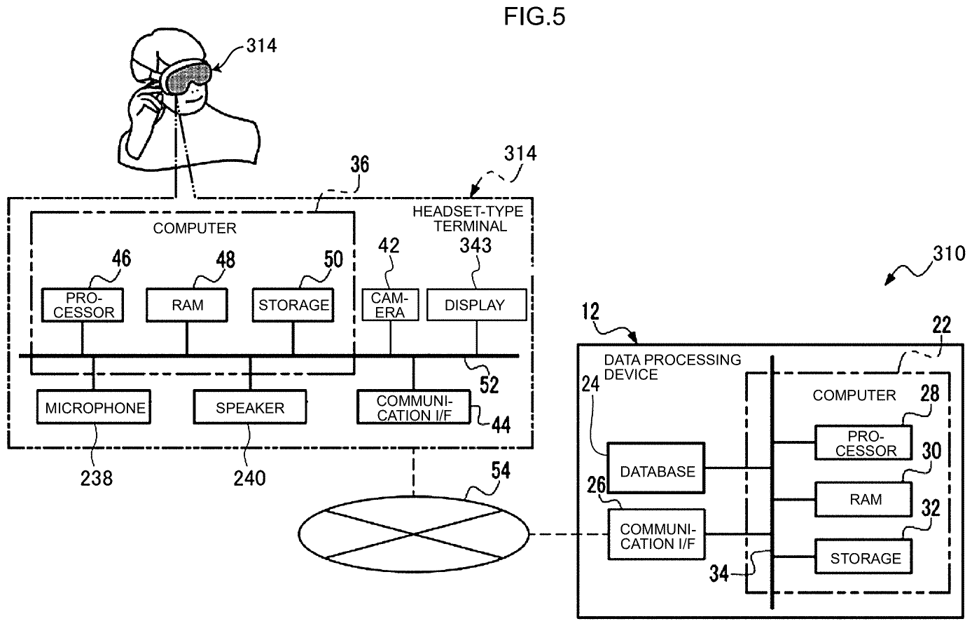

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

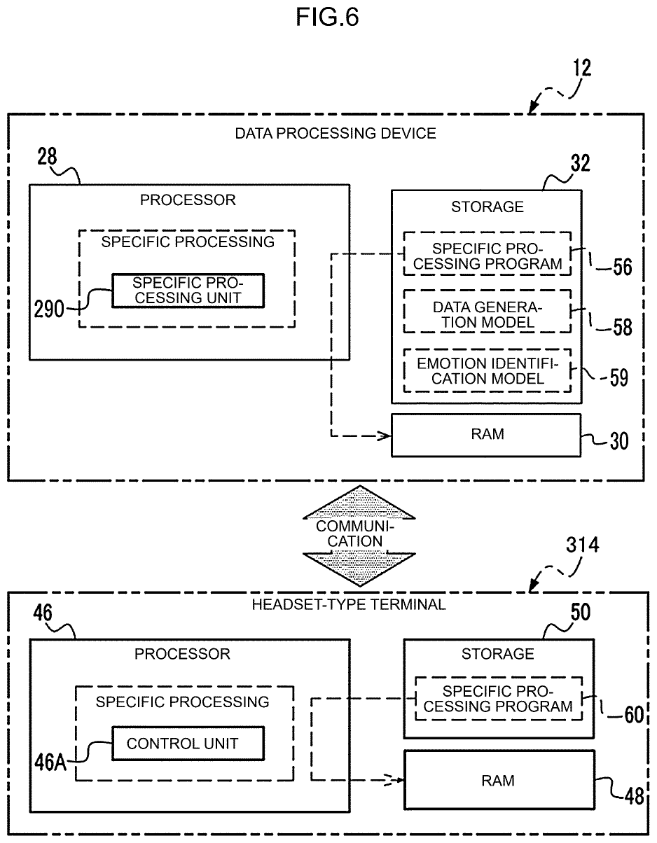

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, analysis unit, proposal unit, signal control unit, parking management unit, and operation adjustment unit is implemented by at least one of, for example, a headset-type terminal 314 and a data processing apparatus 12. For example, the collection unit collects traffic flow data or sensor information using a camera 42 or sensors of the headset-type terminal 314. The analysis unit is implemented, for example, by a specific processing unit 290 of the data processing apparatus 12 and analyzes the collected data. The proposal unit is implemented, for example, by the specific processing unit 290 of the data processing apparatus 12 and proposes an efficient traffic route. The signal control unit is implemented, for example, by the specific processing unit 290 of the data processing apparatus 12 and adjusts signal timing. The parking management unit is implemented, for example, by a control unit 46A of the headset-type terminal 314 and grasps the availability status of parking lots. The operation adjustment unit is implemented, for example, by the specific processing unit 290 of the data processing apparatus 12 and adjusts the operation schedule of public transportation. The correspondence between each unit and the apparatus or control unit is not limited to the above examples and various modifications are possible.

### Fourth Embodiment

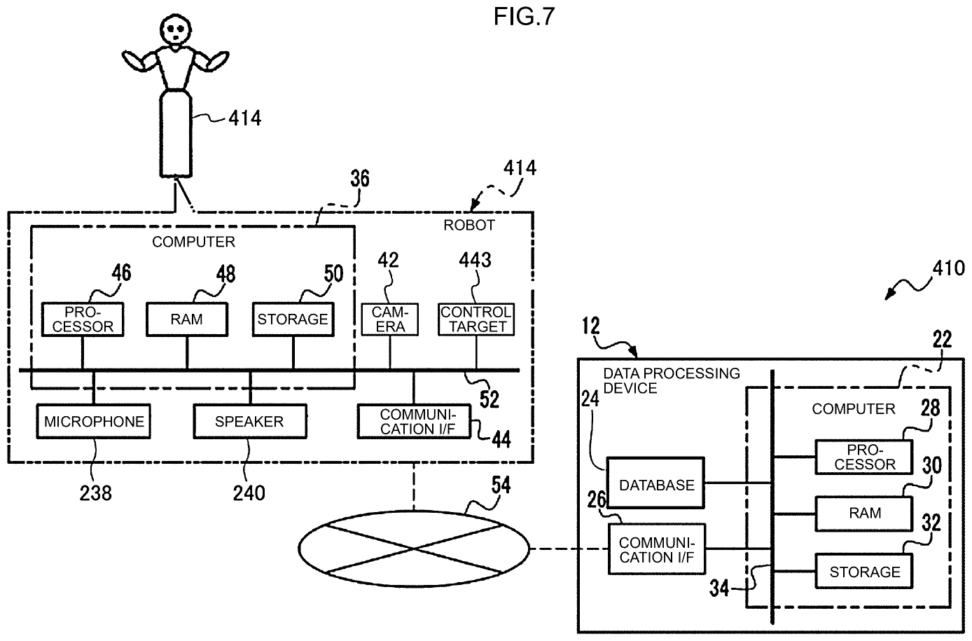

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

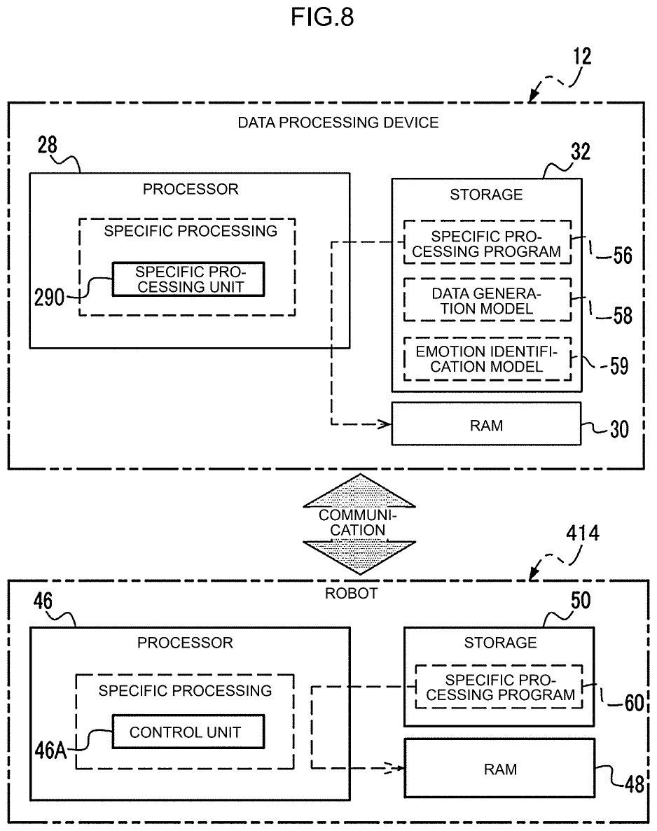

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, analysis unit, proposal unit, signal control unit, parking management unit, and operation adjustment unit is implemented by at least one of, for example, a robot 414 and a data processing apparatus 12. For example, the collection unit collects traffic flow data or sensor information using a camera 42 or sensors of the robot 414. The analysis unit is implemented, for example, by a specific processing unit 290 of the data processing apparatus 12 and analyzes the collected data. The proposal unit is implemented, for example, by the specific processing unit 290 of the data processing apparatus 12 and proposes an efficient traffic route. The signal control unit is implemented, for example, by the specific processing unit 290 of the data processing apparatus 12 and adjusts signal timing. The parking management unit is implemented, for example, by a control unit 46A of the robot 414 and grasps the availability status of parking lots. The operation adjustment unit is implemented, for example, by the specific processing unit 290 of the data processing apparatus 12 and adjusts the operation schedule of public transportation. The correspondence between each unit and the apparatus or control unit is not limited to the above examples and various modifications are possible.

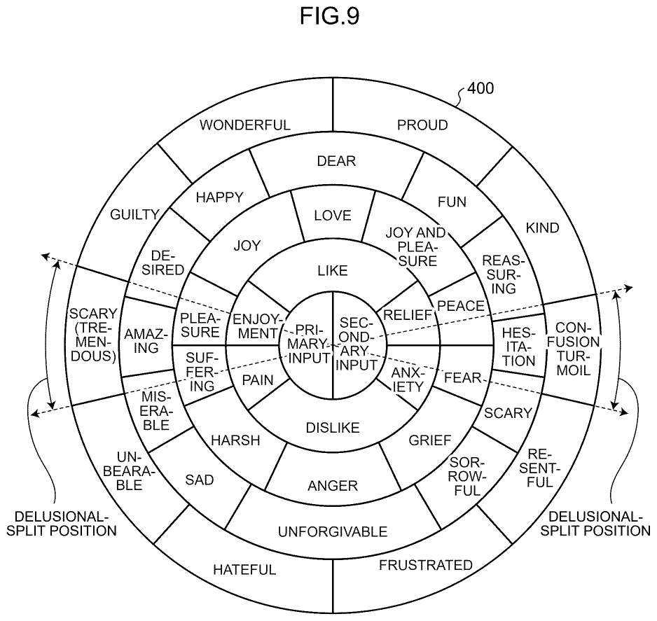

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

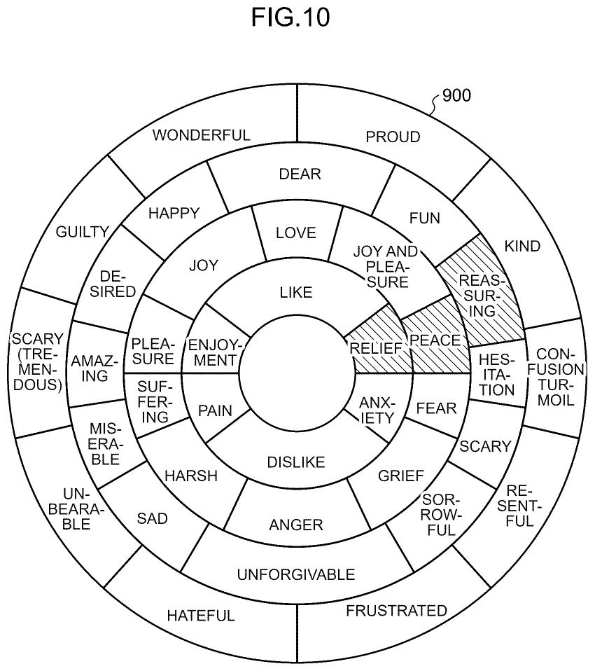

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect traffic flow data or sensor information; an analysis unit configured to analyze data collected by the collection unit; a proposal unit configured to propose a traffic route based on an analysis result obtained by the analysis unit; a signal control unit configured to perform signal control based on a route proposed by the proposal unit; a parking management unit configured to perform parking management based on a route proposed by the proposal unit; and an operation adjustment unit configured to adjust public transportation operation based on a route proposed by the proposal unit.
(Supplementary Note 2) The system according to Supplementary Note 1, wherein the collection unit collects data from sensors or cameras
installed on roads.
(Supplementary Note 3) The system according to Supplementary Note 1, wherein the analysis unit analyzes traffic flow based on the collected data and proposes a route that avoids roads where congestion occurs or a route that reaches a destination by the shortest distance.
(Supplementary Note 4) The system according to Supplementary Note 1, wherein the signal control unit adjusts signal timing based on traffic flow data to smooth the flow of traffic.
(Supplementary Note 5) The system according to Supplementary Note 1, wherein the parking management unit grasps the availability status of parking lots in real time and performs parking management.
(Supplementary Note 6) The system according to Supplementary Note 1, wherein the operation adjustment unit adjusts the operation schedule of public transportation to reduce passenger waiting time.
(Supplementary Note 7) The system according to Supplementary Note 1, wherein the collection unit estimates a user's emotion and sets the timing of data collection based on the estimated user's emotion.
(Supplementary Note 8) The system according to Supplementary Note 1, wherein the collection unit analyzes past traffic data and determines sensor placement.
(Supplementary Note 9) The system according to Supplementary Note 1, wherein the collection unit changes the data collection method according to weather or time zone during data collection.
(Supplementary Note 10) The system according to Supplementary Note 1, wherein the collection unit estimates a user's emotion and sets the priority of data to be collected based on the estimated user's emotion.
(Supplementary Note 11) The system according to Supplementary Note 1, wherein the collection unit adjusts the collection range in consideration of surrounding event information during data
(Supplementary Note 12) The system according to Supplementary Note 1, wherein the collection unit cooperates with other traffic management systems and shares data during data collection.
(Supplementary Note 13) The system according to Supplementary Note 1, wherein the analysis unit estimates a user's emotion and adjusts a display method of an analysis result based on the estimated user's emotion.
(Supplementary Note 14) The system according to Supplementary Note 1, wherein the analysis unit refers to past traffic patterns during analysis to improve prediction accuracy.
(Supplementary Note 15) The system according to Supplementary Note 1, wherein the analysis unit detects abnormal traffic patterns during analysis and issues a warning.
(Supplementary Note 16) The system according to Supplementary Note 1, wherein the analysis unit estimates a user's emotion and determines the priority of analysis results based on the estimated user's emotion.
(Supplementary Note 17) The system according to Supplementary Note 1, wherein the analysis unit improves analysis accuracy by considering surrounding construction information during analysis.
(Supplementary Note 18) The system according to Supplementary Note 1,
(Supplementary Note 19)The system according to Supplementary Note 1, wherein the proposal unit estimates a user's emotion and adjusts a method of expressing proposals based on the estimated user's emotion.
(Supplementary Note 20) The system according to Supplementary Note 1, wherein the proposal unit proposes a route in consideration of the
(Supplementary Note 21) The system according to Supplementary Note 1, wherein the proposal unit proposes a route that minimizes energy consumption during proposal.
(Supplementary Note 22) The system according to Supplementary Note 1, wherein the proposal unit estimates a user's emotion and determines the priority of proposals based on the estimated user's emotion.
(Supplementary Note 23) The system according to Supplementary Note 1, wherein the proposal unit proposes a route in consideration of the operation status of public transportation during proposal.
(Supplementary Note 24) The system according to Supplementary Note 1, wherein the proposal unit proposes a customized route by referring to a user's past movement history during proposal.
(Supplementary Note 25) The system according to Supplementary Note 1, wherein the signal control unit estimates a user's emotion and adjusts signal timing based on the estimated user's emotion.
(Supplementary Note 26) The system according to Supplementary Note 1, wherein the signal control unit prioritizes the passage of emergency vehicles during signal control.
(Supplementary Note 27) The system according to Supplementary Note 1, wherein the signal control unit adjusts signal timing in consideration of pedestrian safety during signal control.
(Supplementary Note 28) The system according to Supplementary Note 1, wherein the signal control unit estimates a user's emotion and determines the priority of signal control based on the estimated user's emotion.
(Supplementary Note 29) The system according to Supplementary Note 1, wherein the signal control unit reflects surrounding traffic
(Supplementary Note 30) The system according to Supplementary Note 1, wherein the signal control unit cooperates with other traffic management systems to optimize signal timing during signal control.
(Supplementary Note 31) The system according to Supplementary Note 1, wherein the parking management unit estimates a user's emotion and adjusts a method of guiding parking lots based on the estimated user's emotion.
(Supplementary Note 32) The system according to Supplementary Note 1, wherein the parking management unit predicts the usage status of parking lots during parking management and proposes an optimal parking location.
(Supplementary Note 33) The system according to Supplementary Note 1, wherein the parking management unit cooperates with a parking reservation system to perform efficient parking management during parking management.
(Supplementary Note 34) The system according to Supplementary Note 1, wherein the parking management unit estimates a user's emotion and determines the priority of parking management based on the estimated user's emotion.
(Supplementary Note 35) The system according to Supplementary Note 1, wherein the parking management unit reflects surrounding parking lot information in real time during parking management.
(Supplementary Note 36) The system according to Supplementary Note 1, wherein the parking management unit cooperates with parking management systems of other cities to improve parking lot utilization efficiency during parking management.
(Supplementary Note 37) The system according to Supplementary Note 1, wherein the operation adjustment unit estimates a user's emotion and adjusts the operation schedule based on the estimated user's emotion.
(Supplementary Note 38) The system according to Supplementary Note 1, wherein the operation adjustment unit analyzes passenger boarding and alighting data during operation adjustment and proposes an optimal operation schedule.
(Supplementary Note 39) The system according to Supplementary Note 1, wherein the operation adjustment unit adjusts the operation schedule in consideration of weather and event information during operation adjustment.
(Supplementary Note 40) The system according to Supplementary Note 1, wherein the operation adjustment unit estimates a user's emotion and determines the priority of operation adjustment based on the estimated user's emotion.
(Supplementary Note 41) The system according to Supplementary Note 1, wherein the operation adjustment unit cooperates with other public transportation systems to improve transfer convenience during operation adjustment.
(Supplementary Note 42) The system according to Supplementary Note 1, wherein the operation adjustment unit refers to operation data of other cities during operation adjustment to optimize the operation schedule.

What is claimed is:

1. A system comprising:
circuitry configured to:
receive, via a communication interface from a sensor network, sensor data comprising at least one of image tensor data or time-series measurement vector data;
extract feature vectors from the sensor data by applying a convolutional neural network to the image tensor data or a recurrent neural network to the time-series measurement vector data;
generate prediction data by inputting the extracted feature vectors into a time-series prediction model, the prediction data comprising score values and recommended identifier data;
generate control signal data based on the prediction data by applying a reinforcement learning model to determine adjustment parameters; and
transmit, via the communication interface, the control signal data and the recommended identifier data to a client terminal.

2. The system according to claim 1, wherein the sensor data comprises data obtained from at least one of a magnetic sensor, a pressure sensor, an infrared sensor, a radar, or a LIDAR.

3. The system according to claim 1, wherein the circuitry is further configured to perform noise removal, normalization, and feature extraction on the sensor data in a preprocessing operation before extracting the feature vectors.

4. The system according to claim 1, wherein the time-series prediction model comprises at least one of a transformer-based model, a recurrent neural network, or a graph neural network.

5. The system according to claim 1, wherein the score values comprise anomaly detection scores indicating a probability of an abnormal pattern in the sensor data.

6. The system according to claim 1, wherein the circuitry is further configured to detect an abnormal pattern in the sensor data using an autoencoder-based anomaly detection model and to generate a warning notification when an anomaly score exceeds a threshold.

7. The system according to claim 1, wherein the circuitry is further configured to input past time-series data comprising at least one year of historical measurement vectors into the time-series prediction model to improve prediction accuracy.

8. The system according to claim 1, wherein the circuitry is further configured to estimate an emotion of a user by applying an emotion identification model to at least one of facial image data, voice waveform data, or biometric sensor data received from the client terminal, and to adjust a representation method of the prediction data based on the estimated emotion.

9. The system according to claim 8, wherein the circuitry is further configured to adjust a timing of transmitting the prediction data based on the estimated emotion, such that when the estimated emotion indicates stress, the circuitry delays transmission to reduce a burden on the user.

10. The system according to claim 1, wherein the circuitry is further configured to determine sensor placement by applying a graph neural network to past measurement data to identify locations where anomalies frequently occur.

11. The system according to claim 1, wherein the circuitry is further configured to change a data collection frequency based on at least one of weather information or time zone information received via the communication interface.

12. The system according to claim 1, wherein the circuitry is further configured to receive event information comprising at least one of an event venue coordinate, an expected number of visitors, or an event time, and to adjust a data collection range based on the event information using a reinforcement learning model.

13. The system according to claim 1, wherein the circuitry is further configured to receive data from other data processing systems via an API, perform format conversion and time-series synchronization on the received data, and integrate the received data with the sensor data using a multimodal fusion model.

14. The system according to claim 1, wherein the circuitry is further configured to adjust the adjustment parameters based on a congestion score, such that when the congestion score exceeds a threshold, the circuitry increases a value of the adjustment parameters.

15. The system according to claim 1, wherein the circuitry is further configured to prioritize passage of emergency vehicles by receiving location information and direction of travel data of an emergency vehicle via the communication interface and generating the control signal data to provide a clear path for the emergency vehicle.

16. The system according to claim 1, wherein the circuitry is further configured to receive boarding and alighting count data from a public transportation system via the communication interface and to generate operation schedule adjustment data by inputting the boarding and alighting count data into the reinforcement learning model.

17. The system according to claim 1, wherein the circuitry is further configured to search a vector database using an approximate nearest neighbor search to acquire reference data related to the sensor data, and to input the acquired reference data together with the extracted feature vectors into a data generation model to generate the recommended identifier data.

18. A system comprising:
a communication interface configured to communicate, via a packet-switched network conforming to at least one of a 5G, Wi-Fi, or Bluetooth communication standard, with a client terminal comprising at least one of a smart device having a touch panel, a microphone, a speaker, a display, and a camera having a CMOS image sensor, smart glasses having a display and a camera, a headset-type terminal having a microphone and a speaker, or a robot having a microphone, a speaker, a camera, and a control target;
a processor;
a random-access memory;
a memory storing a data generation model obtained by deep learning on a neural network, a time-series prediction model, a reinforcement learning model, and an emotion identification model;
a database storing historical measurement data; and
circuitry configured to:
receive, from a sensor network via the communication interface, sensor data comprising at least one of image tensor data captured by a camera, time-series measurement vector data from a magnetic sensor, a pressure sensor, an infrared sensor, a radar, or a LIDAR;
extract feature vectors from the sensor data by applying a convolutional neural network to the image tensor data or a recurrent neural network to the time-series measurement vector data;
generate prediction data by inputting the extracted feature vectors into the time-series prediction model, the prediction data comprising score values and recommended identifier data;
estimate an emotion of a user by applying the emotion identification model to at least one of voice data captured by the microphone or image data captured by the camera of the client terminal;
generate control signal data based on the prediction data by applying the reinforcement learning model to determine adjustment parameters, the control signal data being adapted based on the estimated emotion; and
transmit the control signal data and the recommended identifier data to the client terminal via the communication interface, the control signal data and the recommended identifier data causing the client terminal to present information to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a memory storing a data generation model obtained by deep learning on a neural network, a time-series prediction model, a reinforcement learning model, and an emotion identification model, a database storing historical measurement data, and a communication interface, the method comprising:
receiving, via the communication interface from a sensor network, sensor data comprising at least one of image tensor data or time-series measurement vector data;
extracting feature vectors from the sensor data by applying a convolutional neural network to the image tensor data or a recurrent neural network to the time-series measurement vector data;
generating prediction data by inputting the extracted feature vectors into the time-series prediction model, the prediction data comprising score values and recommended identifier data;
generating control signal data based on the prediction data by applying the reinforcement learning model to determine adjustment parameters; and
transmitting, via the communication interface, the control signal data and the recommended identifier data to a client terminal.
